(19) United States
(12) Patent Application Publication
(10) Pub. No.: US 2014/0101554 A1
(43) Pub. Date: Apr. 10, 2014

(54) Methods, Systems, and Program Products for Exchanging Presentation Data Based on a Communication

(71) Applicant: DEEP RIVER VENTURES, LLC, Raleigh, NC (US)

(72) Inventor: Robert Paul Morris, Raleigh, NC (US)

(73) Assignee: DEEP RIVER VENTURES, LLC, Raleigh, NC (US)

(21) Appl. No.: 13/647,144

(22) Filed: Oct. 8, 2012

(51) Int. Cl. G06F 3/01

(52) U.S. Cl. 715/733

(57) ABSTRACT

Methods and systems are described for exchanging presentation data based on a communication. In an aspect, a view descriptor is exchanged via a communication protocol from a remote communications agent to a local communications agent. The view descriptor is identified by the local communications agent to access presentation data representing remote presentation information sent by a component operating in a remote execution environment including the remote communications agent. A protocol endpoint is configured, based on the view descriptor, in the local execution environment. The presentation data is exchanged, based on the protocol endpoint, from the remote execution environment to the local execution environment. Local presentation information, based on the presentation data, is sent to present a representation of the remote presentation information via an output device of the local execution environment.

### RELATED APPLICATIONS

This application is related to the following pending U.S. patent applications that are not commonly owned but by the same inventor: application Ser. No. 12/833,016 (Docket No 0158) filed on 2010 Jul. 9, entitled “Methods, Systems, and Program Products for Referencing an Attachment in a Communication”; and

application Ser. No. 12/833,014 (Docket No 0155) filed on 2010 Jul. 9, entitled “Methods, Systems, and Program Products for Processing a Request for a Resource in a Communication”.

This application is related to the following commonly owned, pending U.S. patent application Ser. No. 13/624,906 (Docket No DRV00019) filed on 2012 Sep. 22, entitled “Methods, Systems, and Program Products for Processing a Data Object Identification Request in a Communication”;

application Ser. No. 13/626,635 (Docket No DRV0010) filed on 2012 Sep. 25, entitled “Methods, Systems, and Program Products for Sharing a Data Object in a Data Store Via a Communication”; and

application Ser. No. 13/624,940 (Docket No DRV0011) filed on 2012 Sep. 23, entitled “Methods, Systems, and Program Products for Processing a Reference in a Communication to a Remote Data Object”.

### BACKGROUND

A variety of means currently exist that allow a user of one computing device to view a desktop and/or user interface of an application that is hosted, at least for the most part, on a second, remote device where the two devices exchange data via a network. Examples of software, networking protocols, and specifications that enable a local execution environment to access remote desktop and/or user interfaces of applications hosted by a remote execution environment include Virtual Network Computing® (VNC) and variants of VNC, MICROSOFT CORPORATION'S Remote Desktop Connection® (aka Terminal Services) in its various versions, Apple Remote Desktop®, and various products of Citrix Corporation such as WinFrame® and XenDestop®—to name just a few examples.

With respect to presentation protocols, VNC makes use of remote framebuffer protocol (RFP). Remote Desktop Connection® makes use of Remote Desktop Protocol (RDP) in its various versions. Apple Remote Desktop® uses a variant of RFP. WinFrame® and XenDestop® use Citrix's Independent Computing Architecture (ICA) protocol—to name again just a few examples.

Software such as VNC and others extract and compress the graphic interface images for transmission. RFP, VNC's protocol, is specified in “Request for Comments” (RFC) document RFC 6143 by T. Richardson and J. Levine, titled “The Remote Framebuffer Protocol” (March 2011), which is incorporated here in its entirety by reference. VNC's protocol is demand driven by the viewer. Citrix ICA may send GUI image data, but is also capable of offloading part of the GUI processing and generation if the local and remote execution environments allow it. Early versions of Microsoft RDP were similar to ICA, but currently use a kernel level driver to intercept GUI processing and generation before a full GUI image is produced. RDP allows significant offloading of this processing to the viewing execution environment (referred to herein as the local execution environment).

These products and solutions are relatively difficult to configure often requiring a skilled information technology (IT) professional to install, configure, and manage. Further, such products utilize a mix of open source and proprietary technologies making it difficult for any single person, especially a typical user, to be familiar with operating and/or managing more than one of these products and/or solutions.

Accordingly, there exists a need for methods, systems, and computer program products for exchanging presentation data based on a communication.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for exchanging presentation data based on a communication. In one aspect, the method includes identifying, by a local communications agent in a local execution environment, data as a view descriptor, wherein the data is received by the local communications agent in a communication, via a network, with an other communications agent in an other execution environment, wherein the view descriptor is identified for accessing presentation data representing remote presentation information sent by a remote component operating in a remote execution environment for representing in a first presentation space in the remote execution environment. The method further includes configuring, based on the view descriptor, a local protocol endpoint in the local execution environment. The method still further includes receiving, by the local execution environment and based on the local protocol endpoint, the presentation data. The method additionally includes sending local presentation information, based on the presentation data, to present a representation of the remote presentation information via an output device of the local execution environment. Performing at least one the preceding actions, comprising the method, includes execution of an instruction by a processor.

Also, a system for exchanging presentation data based on a communication is described that includes one or more processors and logic encoded in one or more tangible media for execution by the one or more processors that when executed is operable for identifying, by a local communications agent in a local execution environment, data as a view descriptor, wherein the data is received by the local communications agent in a communication, via a network, with an other communications agent in an other execution environment, wherein the view descriptor is identified for accessing presentation data representing remote presentation information sent by a remote component operating in a remote execution environment for representing in a first presentation space in the remote execution environment; configuring, based on the view descriptor, a local protocol endpoint in the local execution environment; receiving, by the local execution environment and based on the local protocol endpoint, the presentation data; and sending local presentation information, based on the presentation data, to present a representation of the remote presentation information via an output device of the local execution environment.

Further, a system for exchanging presentation data based on a communication is described. The system includes a descriptor handler component for identifying, by a local communications agent in a local execution environment, data as a view descriptor, wherein the data is received by the local communications agent in a communication, via a network, with an other communications agent in an other execution environment, wherein the view descriptor is identified for accessing presentation data representing remote presentation information sent by a remote component operating in a remote execution environment for representing in a first presentation space in the remote execution environment. The system further includes an access director component for configuring, based on the view descriptor, a local protocol endpoint in the local execution environment. The system still further includes an access agent component for receiving, by the local execution environment and based on the local protocol endpoint, the presentation data. The system additionally includes a local view manager component for, sending local presentation information, based on the presentation data, to present a representation of the remote presentation information via an output device of the local execution environment The system also includes a processor, wherein at least one of the descriptor handler component, the access director component, the access agent component, and the local view manager component includes an instruction that is executed by the processor during operation of the system.

Methods and systems are described for exchanging presentation data based on a communication. In one aspect, the method includes receiving, by a remote communications agent in a remote execution environment, descriptor information for identifying presentation data representing remote presentation information, sent by a remote component operating in the remote execution environment, to be represented in a first presentation space in the remote execution environment. The method further includes locating, automatically based on the descriptor information, a view descriptor to configure a local protocol endpoint in the local execution environment, wherein the locating is initiated by the remote communications agent. The method still further includes sending, via a communications protocol based on a local communications address identifying a local user represented by a local communications agent in a local execution environment, the view descriptor to the local communications agent by the remote communications agent. The method additionally includes sending, based on the local protocol endpoint to the local execution environment, the presentation data.

Also, a system for exchanging presentation data based on a communication is described that includes one or more processors and logic encoded in one or more tangible media for execution by the one or more processors that when executed is operable for receiving, by a remote communications agent in a remote execution environment, descriptor information for identifying presentation data representing remote presentation information, sent by a remote component operating in the remote execution environment, to be represented in a first presentation space in the remote execution environment; locating, automatically based on the descriptor information, a view descriptor to configure a local protocol endpoint in the local execution environment, wherein the locating is initiated by the remote communications agent; sending, via a communications protocol based on a local communications address identifying a local user represented by a local communications agent in a local execution environment, the view descriptor to the local communications agent by the remote communications agent; and sending, based on the local protocol endpoint to the local execution environment, the presentation data.

Further, a system for exchanging presentation data based on a communication is described. The system includes a remote view manager component for receiving, by a remote communications agent in a remote execution environment, descriptor information for identifying presentation data representing remote presentation information, sent by a remote component operating in the remote execution environment, to be represented in a first presentation space in the remote execution environment. The system further includes a descriptor generator component for locating, automatically based on the descriptor information, a view descriptor to configure a local protocol endpoint in the local execution environment, wherein the locating is initiated by the remote communications agent. The system still further includes a remote view content handler component for sending, via a communications protocol based on a local communications address identifying a local user represented by a local communications agent in a local execution environment, the view descriptor to the local communications agent by the remote communications agent. The system additionally includes an access server component for sending, based on the local protocol endpoint to the local execution environment, the presentation data. The system also includes a processor, wherein at least one of the remote view manager component, the descriptor generator component, the remote view content handler component, and the access server component includes an instruction that is executed by the processor during operation of the system.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2A is a flow diagram illustrating a method for exchanging presentation data based on a communication according to an aspect of the subject matter described herein;

FIG. 2B is a flow diagram illustrating a method for exchanging presentation data based on a communication according to an aspect of the subject matter described herein;

FIG. 3A is a block diagram illustrating an arrangement of components for exchanging presentation data based on a communication according to another aspect of the subject matter described herein;

FIG. 3B is a block diagram illustrating an arrangement of components for exchanging presentation data based on a communication according to another aspect of the subject matter described herein;

FIG. 4 is a block diagram illustrating an arrangement of components for exchanging presentation data based on a communication according to another aspect of the subject matter described herein;

FIG. 5 is a network diagram illustrating a system for exchanging presentation data based on a communication according to another aspect of the subject matter described herein;

FIG. 6A is a diagram illustrating a user interface presented via a display according to another aspect of the subject matter described herein;

FIG. 6B is a diagram illustrating a user interface presented via a display according to another aspect of the subject matter described herein;

FIG. 6C is a diagram illustrating a user interface presented via a display according to another aspect of the subject matter described herein;

FIG. 6D is a diagram illustrating a user interface presented via a display according to another aspect of the subject matter described herein;

FIG. 6E is a diagram illustrating a user interface presented via a display according to another aspect of the subject matter described herein;

FIG. 6F is a diagram illustrating a user interface presented via a display according to another aspect of the subject matter described herein;

FIG. 6G is a diagram illustrating a user interface presented via a display according to another aspect of the subject matter described herein;

FIG. 7 is a message flow diagram illustrating an exemplary data and execution flow for exchanging presentation data based on a communication according to an aspect of the subject matter described herein;

FIG. 8A illustrates an exemplary portion of a communication between an execution environment of a remote node and an execution environment of a local node according to an aspect of the subject matter described herein; and

FIG. 8B illustrates another exemplary portion of a communication between an execution environment of a remote node and an execution environment of a local node according to an aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure.

Unless otherwise defined, all technical and scientific terms used herein have the same meaning as commonly understood by one of ordinary skill in the art to which this disclosure belongs. Although methods, components, and devices similar or equivalent to those described herein can be used in the practice or testing of the present invention, suitable methods, components, and devices are described below.

All publications, patent applications, patents, and other references mentioned herein are incorporated by reference in their entirety. In case of conflict, the present disclosure, including definitions, will control. In addition, the materials, methods, and examples are illustrative only and not intended to be limiting.

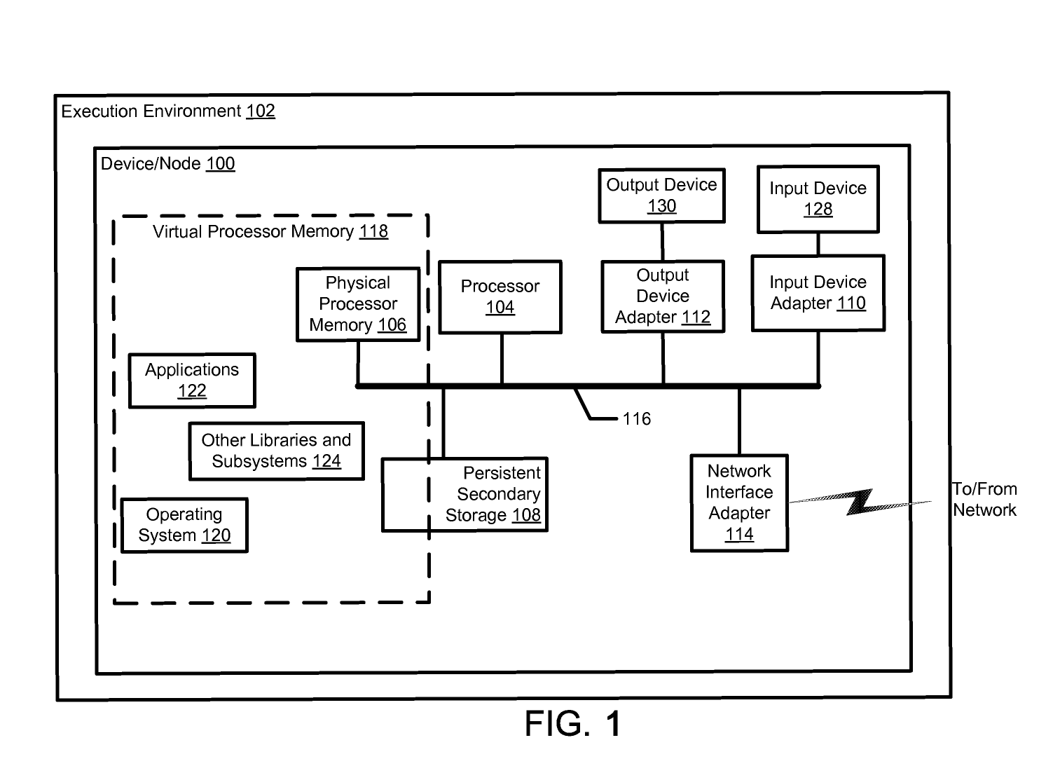

An exemplary device included in an execution environment that may be configured according to the subject matter is illustrated in FIG. 1. An “execution environment”, as used herein, is an arrangement of hardware and, in some aspects, software that may be further configured to include and/or otherwise host an arrangement of components for performing a method of the subject matter described herein. An execution environment includes and/or is otherwise provided by one or more devices. The execution environment is said to be the execution environment of the device and/or devices. An execution environment may be and/or may include a virtual execution environment including software components operating in a host execution environment. Exemplary devices included in and/or otherwise providing suitable execution environments for configuring according to the subject matter include personal computers, notebook computers, tablet computers, servers, portable electronic devices, handheld electronic devices, mobile devices, multiprocessor devices, distributed systems, consumer electronic devices, routers, communication servers, and/or any other suitable devices. Those skilled in the art will understand that the components illustrated in FIG. 1 are exemplary and may vary by particular execution environment.

FIG. 1 illustrates a hardware device 100 included in an execution environment 102. FIG. 1 illustrates that execution environment 102 includes a processor 104, such as one or more microprocessors; a physical processor memory 106 including storage locations identified by addresses in a physical memory address space of processor 104; a persistent secondary storage 108, such as one or more hard drives and/or flash storage media; an input device adapter 110, such as a key or keypad hardware, a keyboard adapter, and/or a mouse adapter; an output device adapter 112, such as a display and/or an audio adapter for presenting information to a user; a network interface component, illustrated by a network interface adapter 114, for communicating via a network such as a LAN and/or WAN; and a communication mechanism that operatively couples elements 104-114, illustrated as a bus 116. Elements 104-114 may be operatively coupled by various means. Bus 116 may comprise any type of bus architecture, including a memory bus, a peripheral bus, a local bus, and/or a switching fabric.

As used herein a “processor” is an instruction execution machine, apparatus, or device. A processor may include one or more electrical, optical, and/or mechanical components that operate in interpreting and executing program instructions. Exemplary processors include one or more microprocessors, digital signal processors (DSPs), graphics processing units, application-specific integrated circuits (ASICs), optical or photonic processors, and/or field programmable gate arrays (FPGAs). Processor 104 may access machine code instructions and data via one or more memory address spaces in addition to the physical memory address space. A memory address space includes addresses identifying locations in a processor memory. The addresses in a memory address space are included in defining a processor memory. Processor 104 may have more than one processor memory. Thus, processor 104 may have more than one memory address space. Processor 104 may access a location in a processor memory by processing an address identifying the location. The processed address may be identified by an operand of a machine code instruction and/or may be identified by a register or other portion of processor 104.

FIG. 1 illustrates a virtual processor memory 118 spanning at least part of physical processor memory 106 and may span at least part of persistent secondary storage 108. Virtual memory addresses in a memory address space may be mapped to physical memory addresses identifying locations in physical processor memory 106. An address space for identifying locations in a virtual processor memory is referred to as a virtual memory address space; its addresses are referred to as virtual memory addresses; and its processor memory is referred to as a virtual processor memory or virtual memory. The term “processor memory” may refer to physical processor memory, such as processor memory 106, and/or may refer to virtual processor memory, such as virtual processor memory 118, depending on the context in which the term is used.

Physical processor memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), RAMBUS DRAM (RDRAM), and/or XDR™ DRAM. Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable data storage medium. The drives and their associated tangible computer readable storage media provide volatile and/or nonvolatile storage for computer-readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including an operating system 120, one or more applications 122, and other program code and/or data components illustrated by other libraries and subsystems 124. In an aspect, some or all software components may be stored in locations accessible to processor 104 in a shared memory address space shared by the software components. The software components accessed via the shared memory address space are stored in a shared processor memory defined by the shared memory address space. In another aspect, a first software component may be stored in one or more locations accessed by processor 104 in a first address space and a second software component may be stored in one or more locations accessed by processor 104 in a second address space. The first software component is stored in a first processor memory defined by the first address space and the second software component is stored in a second processor memory defined by the second address space.

Software components typically include instructions executed by processor 104 in a computing context referred to as a “process”. A process may include one or more “threads”. A “thread” includes a sequence of instructions executed by processor 104 in a computing sub-context of a process. The terms “thread” and “process” may be used interchangeably herein when a process includes only one thread.

Execution environment 102 may receive user-provided information via one or more input devices illustrated by an input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding network interfaces such as a serial port, a parallel port, and/or a universal serial bus (USB) port. Input device adapter 110 receives input and provides a representation to bus 116 to be received by processor 104, physical processor memory 106, and/or other components included in execution environment 102.

An output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred herein to as “sensory input” with respect to the user.

A device included in and/or otherwise providing an execution environment may operate in a networked environment communicating with one or more devices via one or more network interface components. FIG. 1 illustrates network interface adapter (NIA) 114 as a network interface component included in execution environment 102 to operatively couple device 100 to a network. A network interface component includes a network interface hardware (NIH) component and optionally a network interface software (NIS) component.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component to operatively couple the device to a network. Further, the terms “device” and “node” used herein may refer to one or more devices and nodes, respectively, providing and/or otherwise included in an execution environment unless clearly indicated otherwise.

The user-detectable outputs of a user interface are generically referred to herein as “user interface elements” or abbreviated as “UI elements”. More specifically, visual outputs of a user interface are referred to herein as “visual interface elements”. A visual interface element may be a visual output of a graphical user interface (GUI). Exemplary visual interface elements include icons, image data, graphical drawings, font characters, windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes, and radio buttons. An application interface may include one or more of the elements listed. Those skilled in the art will understand that this list is not exhaustive. The terms “visual representation”, “visual output”, and “visual interface element” are used interchangeably in this document. Other types of UI elements include audio outputs referred to as “audio interface elements”, tactile outputs referred to as “tactile interface elements”, and the like.

A visual output may be presented in a two-dimensional presentation where a location may be defined in a two-dimensional space having a vertical dimension and a horizontal dimension. A location in a horizontal dimension may be referenced according to an X-axis and a location in a vertical dimension may be referenced according to a Y-axis. In another aspect, a visual output may be presented in a three-dimensional presentation where a location may be defined in a three-dimensional space having a depth dimension in addition to a vertical dimension and a horizontal dimension. A location in a depth dimension may be identified according to a Z-axis. A visual output in a two-dimensional presentation may be presented as if a depth dimension existed allowing the visual output to overlie and/or underlie some or all of another visual output.

A “user interface (UI) element handler” component, as the term is used in this document, includes a component configured to send information representing a program entity for presenting a user-detectable representation of the program entity by an output device, such as a display. A “program entity” is an object included in and/or otherwise processed by an application or executable. The user-detectable representation is presented based on the sent information. Information that represents a program entity for presenting a user detectable representation of the program entity by an output device is referred to herein as “presentation information”. Presentation information may include and/or may otherwise identify data in one or more formats. Exemplary formats include pixel data formats, image formats such as JPEG, video formats such as MP4, markup language data such as hypertext markup language (HTML) and other XML-based markup, a bit map, and/or instructions such as those defined by various script languages, byte code, and/or machine code. For example, a web page received by a browser from a remote application provider may include HTML, ECMAScript, and/or byte code for presenting one or more UI elements included in a user interface of the remote application. Components configured to send information representing one or more program entities for presenting particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided for storing and/or otherwise representing presentation information, which may include audio, visual, tactile, and/or other sensory data for presentation by and/or on an output device. For example, a buffer for storing an image and/or text string may be a presentation space as sensory information for a user. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

As used herein, the terms “program” and “executable” refer to any data representation that may be translated into a set of machine code instructions and may optionally include associated program data. The terms are used interchangeably herein. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear the state of the object code when it is relevant. This definition can include machine code and virtual machine code, such as Java™ byte code. As used herein, the terms “application”, and “service” may be realized in one or more executables and/or in one or more hardware components. The terms are used interchangeably herein.

As used herein, the term “network protocol” refers to a formal set of rules, conventions and data structures that governs how computers and other network devices exchange information over a network. The rules, conventions, and data structures are said to be specified or defined in a schema, which is also referred to herein as a specification.

The term “network path” as used herein refers to a sequence of nodes in a network that are communicatively coupled for transmitting data in one or more data units of a network protocol between a pair of nodes in the network.

A “data unit”, as the term is used herein, is an entity specified according to a network protocol for transmitting data between a pair of nodes in a network path to send the data from a source node to a destination node that includes a protocol endpoint of the network protocol. A network protocol explicitly and/or implicitly specifies and/or otherwise identifies a schema that defines one or more of a rule for a format for a valid data unit and a vocabulary for content of a valid data unit. One example of a data unit is an Internet Protocol (IP) packet. The Internet Protocol defines rules for formatting for an IP packet that defines a header for identifying a destination address that identifies a destination node and a payload portion for including a representation of data to be delivered to the identified destination node. Various address types are specified defining a vocabulary for one or more address portions of an IP data unit. The terms “data unit”, “data packet”, and “packet” are used interchangeably herein. One or more data units of a first network protocol may transmit a message of second network protocol. For example, one or more data units of the IP protocol may include a TCP message. In another example, one or more TCP data units may transmit an HTTP message.

How data is packaged in one more data units for a network protocol may vary as the data traverses a network path from a source node to a destination node. Data may be transmitted in a single data unit between two consecutive nodes in a network path. Additionally, data may be exchanged between a pair of consecutive nodes in several data units each including a portion of the data. Data received in a single data unit by a node in a network path may be split into portions included in several respective data units for transmitting to a next node in the network path. Portions of data received in several data units may be combined into a single data unit for transmitting by a node in a network path. For purposes of describing the subject matter, a data unit in which data is received by a node is referred to as a different data unit than a data unit in which the data is forwarded by the node.

A “protocol address”, as the term is used herein, for a network protocol is an identifier of a protocol endpoint that may be represented in a data unit of the protocol. For example 192.168.1.1 is an IP protocol address represented in a human readable format that may be included in an address portion of an IP header to identify a source and/or a destination IP protocol endpoint. A protocol address differs from a symbolic identifier, defined below, in that a symbolic identifier, with respect to a network protocol, maps to a protocol address. Thus, “www. maynode.com” may be a symbolic identifier for a node in a network when mapped to the protocol address 192.168.1.1. An identifier may be both a symbolic identifier and a protocol address depending on its role with respect to its use for a particular network protocol.

Since a protocol endpoint is included in a node and is accessible via a network via a network interface, a protocol address identifies a node and identifies a network interface of the node. A network interface may include one or more NICs operatively coupled to a network.

An “interaction”, as the term is used herein, refers to any activity including a user and an object where the object is a source of sensory data detected by the user. In an interaction the user directs attention to the object. An interaction may also include the object as a target of input from the user. The input from the user may be provided intentionally or unintentionally by the user. For example, a rock being held in the hand of a user is a target of input, both tactile and energy input, from the user. A portable electronic device is a type of object. In another example, a user looking at a portable electronic device is receiving sensory data from the portable electronic device whether the device is presenting an output via an output device or not. The user manipulating an input component of the portable electronic device exemplifies the device, as an input target, receiving input from the user. Note that the user in providing input is detecting sensory information from the portable electronic device provided that the user directs sufficient attention to be aware of the sensory information and provided that no disabilities prevent the user from processing the sensory information. An interaction may include an input from the user that is detected and/or otherwise sensed by the device. An interaction may include sensory information that is detected by a user included in the interaction that is presented by an output device included in the interaction.

As used herein “interaction information” refers to any information that identifies an interaction and/or otherwise provides data about an interaction between a user and an object, such as a portable electronic device. Exemplary interaction information may identify a user input for the object, a user-detectable output presented by an output device of the object, a user-detectable attribute of the object, an operation performed by the object in response to a user, an operation performed by the object to present and/or otherwise produce a user-detectable output, and/or a measure of interaction. The term “operational component” of a device, as used herein, refers to a component included in performing an operation by the device.

Interaction information for one object may include and/or otherwise identify interaction information for another object. For example, a motion detector may detect user's head turn in the direction of a display of a portable electronic device. Interaction information identifying the user's head is facing the display may be received and/or used as interaction information for the portable electronic device indicating the user is receiving visual input from the display. The interaction information may serve to indicate a lack of user interaction with one or more other objects in directions from the user different than the detected direction, such as a person approaching the user from behind the user. Thus the interaction information may serve as interaction information for one or more different objects.

As used herein, any reference to an entity “in” an association is equivalent to describing the object as “identified” by the association, unless explicitly indicated otherwise.

As used herein, the term “communication” refers to information including a data sent and/or for sending via a network between communicants. The term “communicant” as used herein refers to a user included in a communication as a sender and/or a receiver of the information. A communicant is represented by a “communications agent” configured to operate in an execution environment to send data to and/or receive data from another communications agent, on behalf of the represented communicant, according to a communications protocol via network. A “communications protocol” defines and/or otherwise identifies an address space including communications addresses for delivering data sent in a communication from one communications agent to another. A communications protocol defines a rule or rules for constructing, transmitting, receiving and/or otherwise processing a data unit or message of the communications protocol. Exemplary communications protocols include SMTP, POP, an instant message (IM) protocol, a short message service (SMS) protocol, a multimedia message service (MMS) protocol, a Voice over IP (VOIP) protocol. Exemplary communication protocol data units include email messages, instant messages, and VOIP audio streams.

The term “attachment” as used herein refers to a portion of a communication that includes data from one communicant to another other than data in the communicant message portion. A resource sent as an attachment is data that is typically not presented “inline” or in a communicant message included in a message portion of a communication. Email attachments are perhaps the most widely known attachments included in communications. An email attachment is a file or other resource sent in a portion of the email separate from a communicant message portion. As defined, other types of communicant messages may be sent in a communication that includes an attachment. A communication may include one or more resources as one or more attachments.

The term “presentation data” as used herein refers to data that is exchangeable via a network between a second execution environment and a first execution environment, that may be transformed by the second execution environment into and/or otherwise may include second presentation information for presenting via an output device of the second execution environment. Further, the presentation data includes and/or is a transformation of first presentation information, from a component operating in the first execution environment, for presenting in a presentation space of the first execution environment. An execution environment operating in the role of the first execution environment as defined above is referred to herein as a “remote execution environment” or equivalently as an “execution environment of a remote node” where the remote node is included in and/or otherwise is included in providing the remote execution environment. An execution environment operating in the role of the second execution environment as defined above is referred to herein as a “local execution environment” or equivalently as an “execution environment of a local node” where the local node is included in and/or otherwise is included in providing the local execution environment.es

The term “view source” as used herein refers to any source of presentation data and/or data included in generating presentation data. Exemplary view sources include applications, any component included in processing presentation information and/or data generated from presentation information in the process of presenting a UI element via a output device, presentation spaces, presentation information, and/or UI elements. An application and/or other component may be identified as a file or other data in a data store that includes instructions that may be executed in an execution environment to send presentation information to present a user interface including one or more UI elements. Alternatively or additionally, an application and/or other executable component may be identified via a process and/or thread, in a process of an executable environment, that when active in the execution environment sends presentation information to present a user interface including one or more UI elements.

The term “view request” as used herein refers to data includable in a data unit of a communications protocol that requests a view descriptor from a communications agent identified to receive data in the data unit based on a communications address of a communicant represented by the receiving communications agent. The communications address is in an address space of the communications protocol. A view request is based on a schema that specifies a rule and/or a vocabulary for detecting that a data entity includes a view request and/or for constructing a valid view request. The term constructing used in this context includes creating a view request and/or modifying an existing view request.

The term “view information” as used herein refers to data processed by a local execution environment to create and/or modify a view request. For example, view information may identify an application, a desktop, a UI element, and/or any other view source in a remote execution environment.

The term “view descriptor” as used herein refers to data includable in a data unit of a communications protocol that allows a receiving communications agent to configure and/or otherwise initiate configuring of a network protocol endpoint in an execution environment of the receiving communications agent. The network protocol endpoint is included in processing to receive presentation data from a remote execution environment. The receiving communications agent is identified to receive data in the data unit based on a communications address of a communicant represented by the receiving communications agent. The communications address is in an address space of the communications protocol. A view descriptor is based on a schema that specifies a rule and/or a vocabulary for identifying that a data entity includes a view descriptor and/or for constructing a valid view descriptor. The term constructing used in this context includes creating a view descriptor and/or modifying an existing view descriptor.

The term “descriptor information” as used herein refers to data processed by a remote execution environment to create and/or modify a view descriptor as defined above. For example, descriptor information may identify a view request, an application, a desktop, a UI element, and/or any other view source in the remote execution environment.

The term “presentation request” as used herein refers to data includable in a data unit of a network protocol that requests from a remote execution environment presentation data from a view source identified by a view descriptor. The network protocol, in an aspect, may be a presentation protocol defined for exchanging presentation data. Exemplary presentation protocols include a VNC protocol, an ICA protocol, and a remote desktop protocol. In another aspect, the network protocol may be a communications protocol, such as a SMTP, POP, an instant message (IM) protocol, a short message service (SMS) protocol, a multimedia message service (MMS) protocol, a Voice over IP (VOIP) protocol. A presentation request is based on a schema that specifies a rule and/or a vocabulary for identifying that a data entity includes a presentation request and/or for constructing a valid presentation request. The term constructing used in this context includes creating a presentation request and/or modifying an existing presentation request.

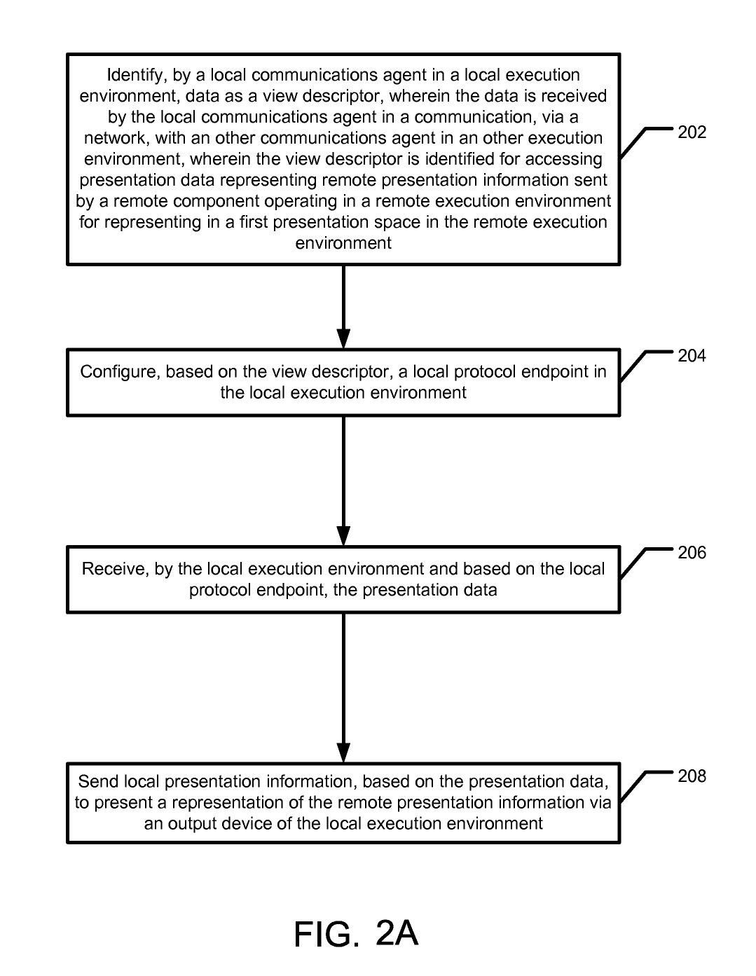

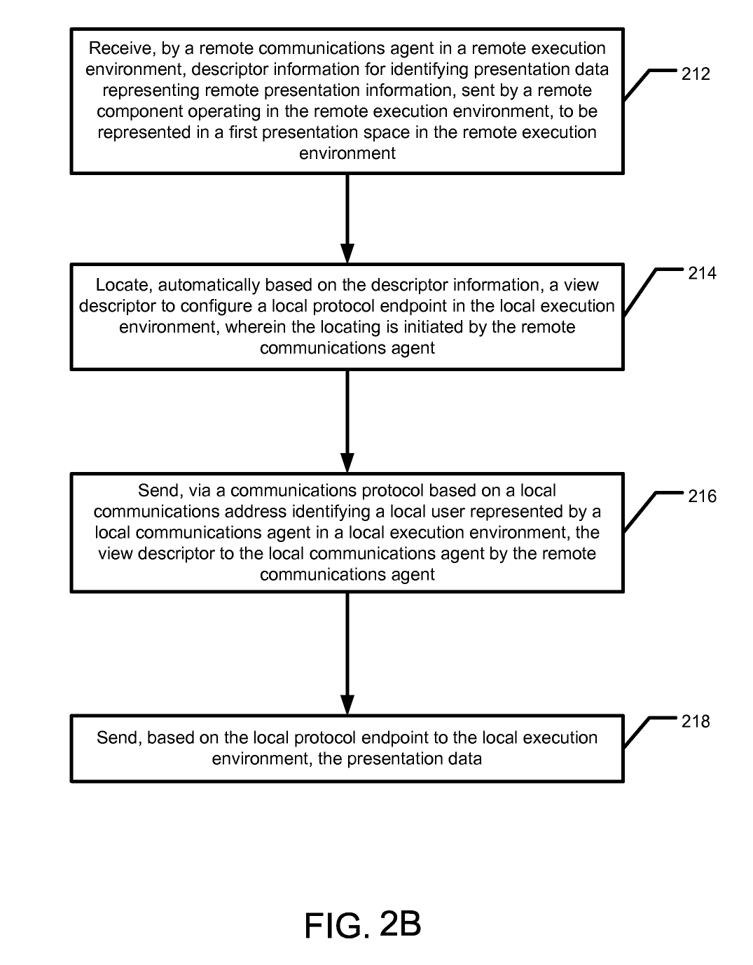

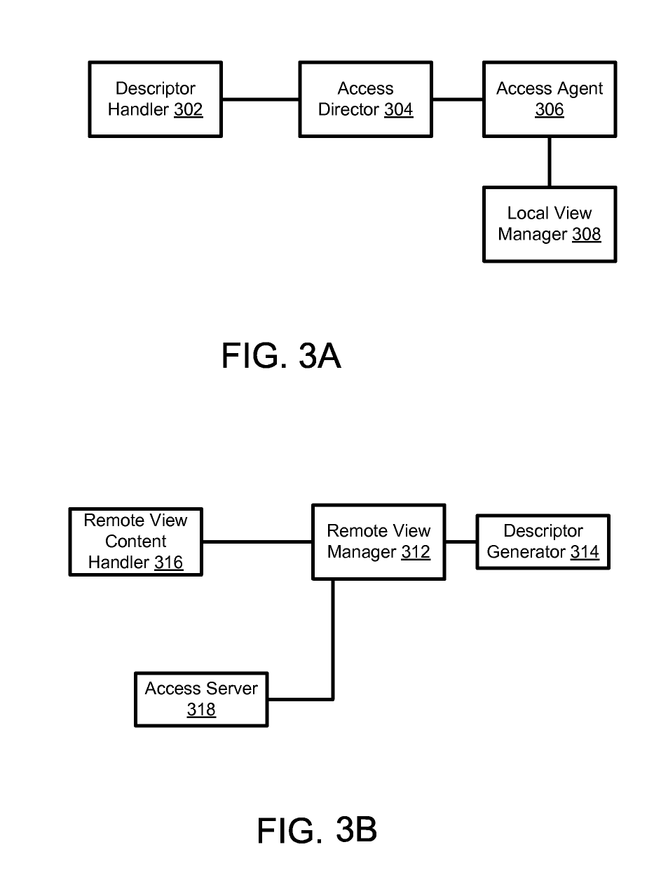

FIG. 3A illustrates an arrangement of components in a system that operates in an execution environment, such as execution environment 102 in FIG. 1. The arrangement of components in the system operates to perform the method illustrated in FIG. 2A. The system illustrated includes a descriptor handler component 302, an access director component 304, an access agent component 306, and a local view manager component 308. A suitable execution environment includes a processor, such as processor 104, to process an instruction in at least one of a descriptor handler component, an access director component, an access agent component, and a local view manager component. FIG. 3B illustrates an arrangement of components in a system that operates to perform the method illustrated in FIG. 2B. The system illustrated includes a remote view manager component 312, a descriptor generator component 314, a remote view content handler component 316, and an access server component 318. A suitable execution environment includes a processor, such as processor 104, to process an instruction in at least one of a remote view manager component, a descriptor generator component, a remote view content handler component, and an access server component.

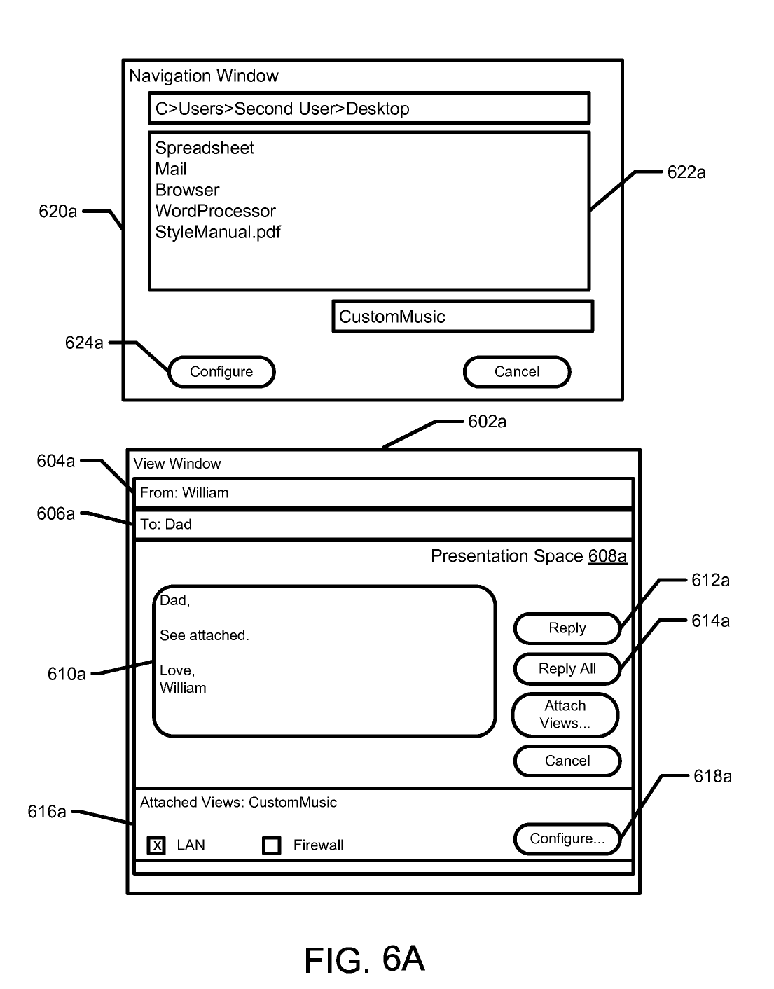

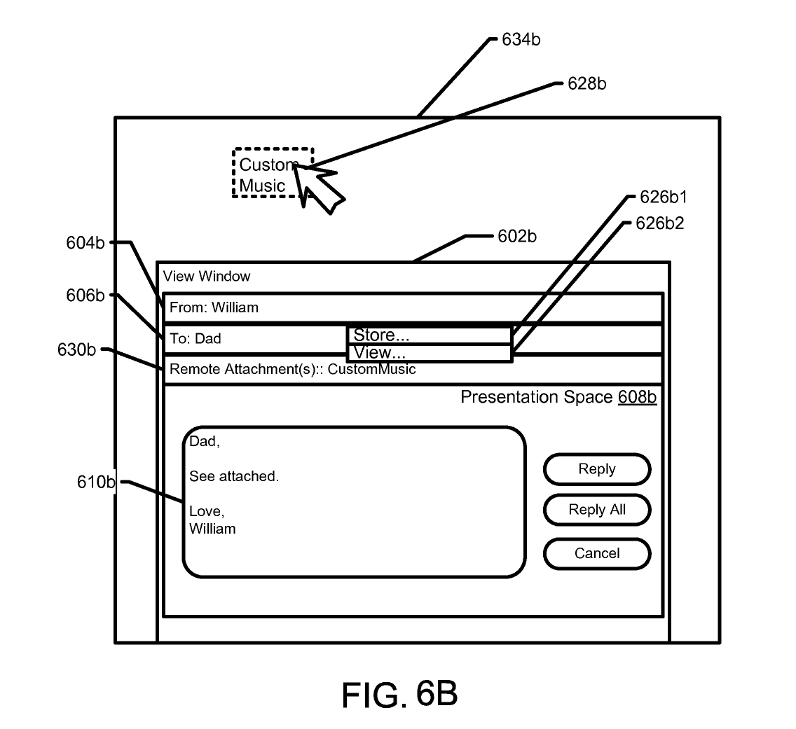

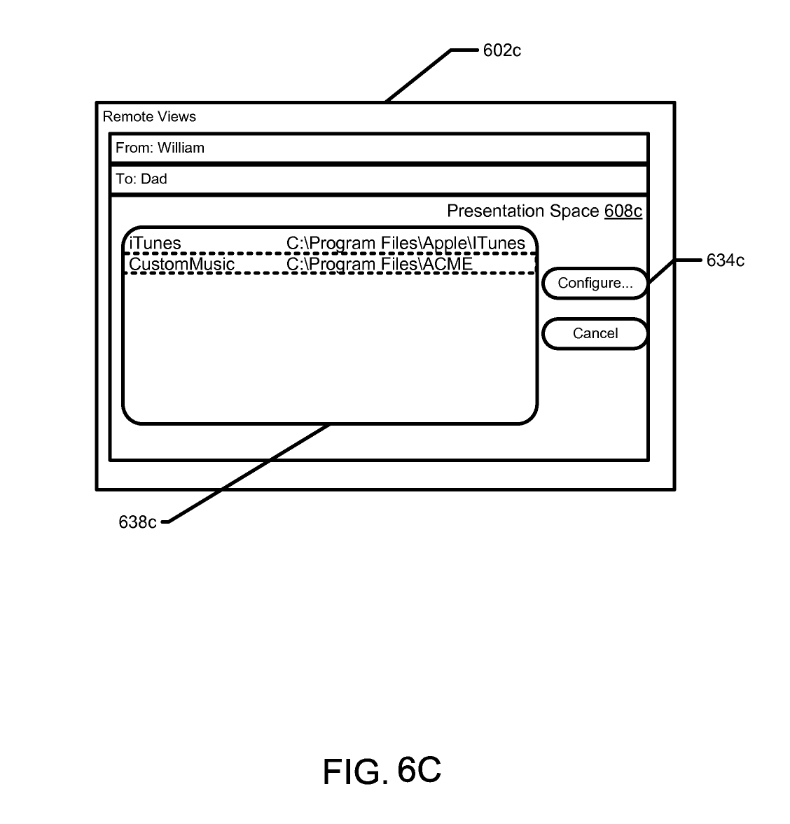

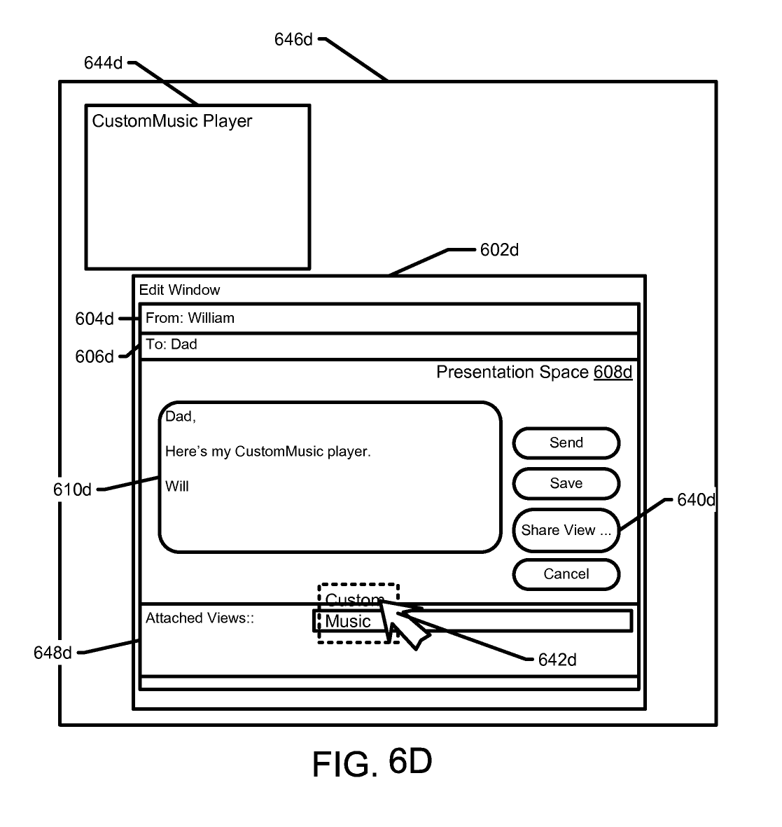

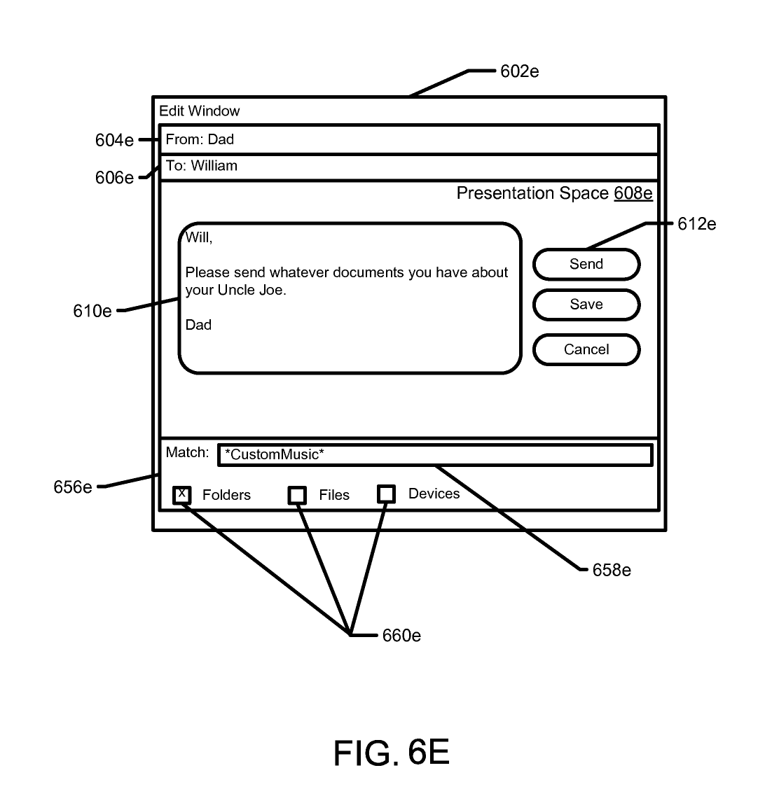

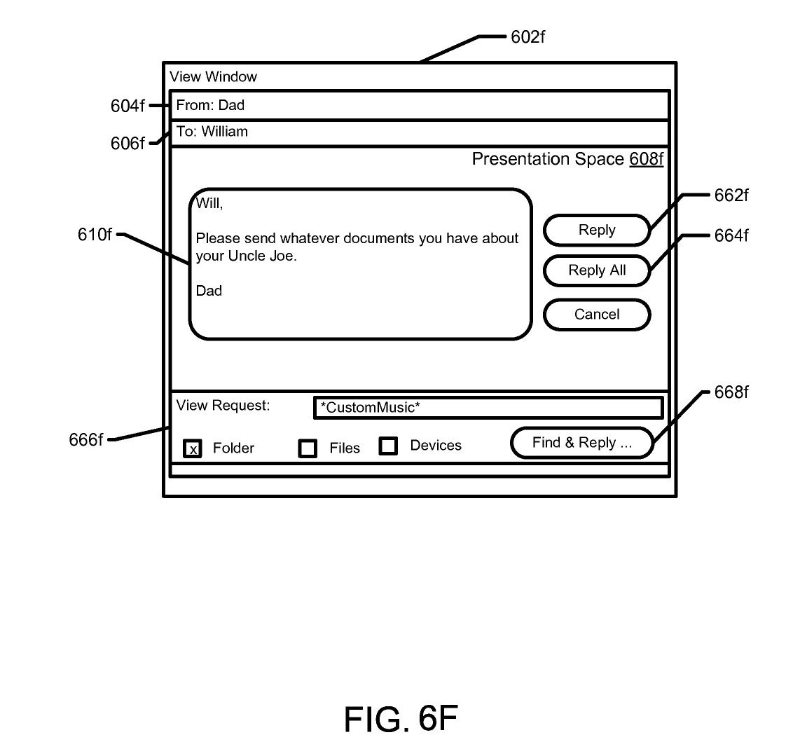

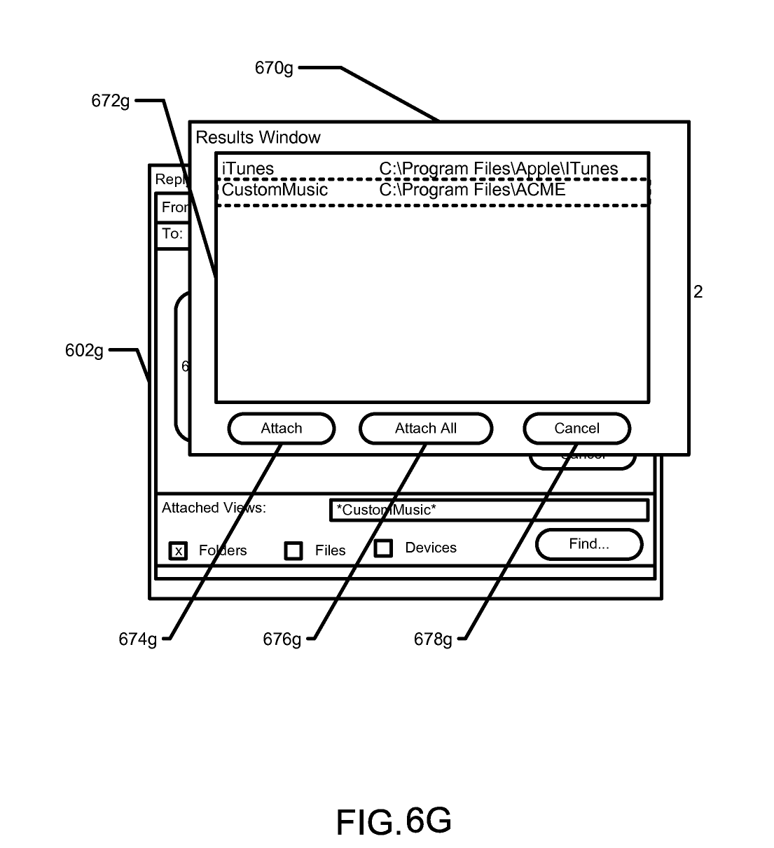

Some components, illustrated in the drawings are identified by numbers with an alphanumeric suffix. A component may be referred to generically in the singular or the plural by dropping a suffix of a portion thereof of the component's identifier. For example, window UI elements, such as a window UI element 602a in FIG. 6A, a window UI element 602a in FIG. 6A, and their adaptations and analogs; are referred to herein generically as a window UI element 602 or window UI elements 602 when describing more than one. Other components identified with an alphanumeric suffix may be referred to generically or as a group in a similar manner.

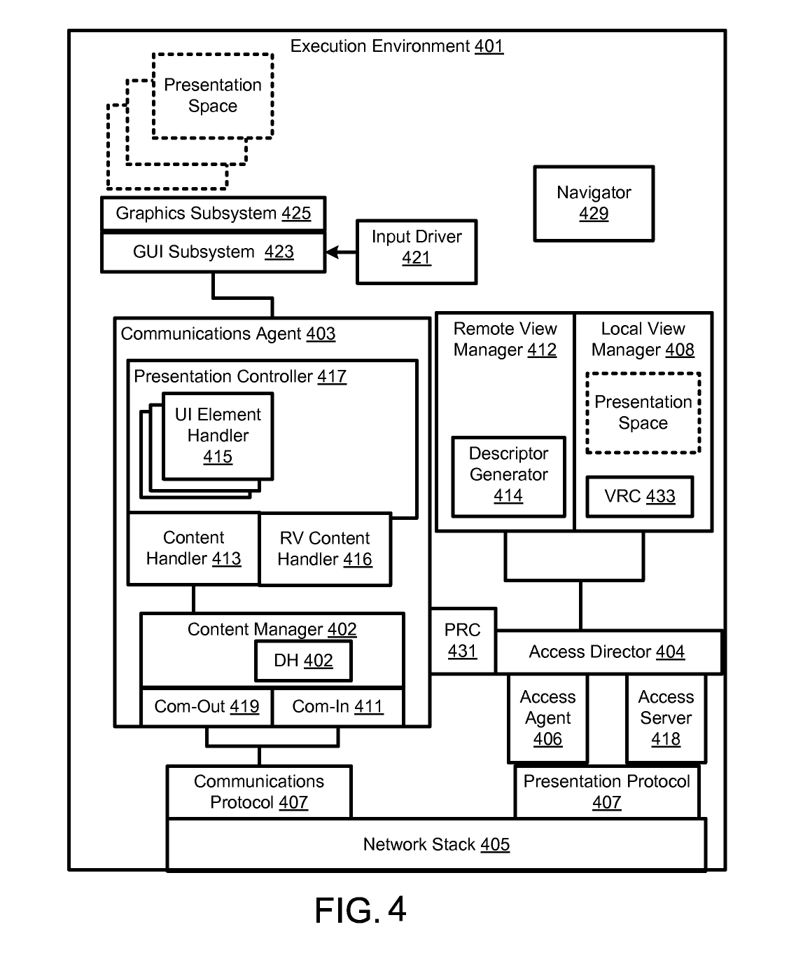

The arrangement of components illustrated in FIG. 4 may be adapted to operate in a number of execution environments to perform the method illustrated in FIG. 2A and/or the method illustrated in FIG. 2B. FIG. 4 is a block diagram illustrating the components of FIG. 3A, FIG. 3B, and/or analogs of the components of FIG. 3A and FIG. 3B, respectively adapted to operate in an execution environment 401 that includes and/or otherwise is provided by one or more nodes. FIG. 1 illustrates key components of an exemplary device that may at least partially provide and/or otherwise be included in an execution environment. The components illustrated in FIG. 4 may be included in or otherwise combined with the components of FIG. 1 to create a variety of arrangements of components according to the subject matter described herein.

As stated, the various adaptations and analogs of the arrangement in FIG. 3A as well as the various adaptations and analogs of the arrangement in FIG. 3B illustrated and described herein are not exhaustive. For example, those skilled in the art will see based on the description herein that arrangements of components for performing the method illustrated in FIG. 2A and the method illustrated in FIG. 2B may each be distributed across more than one node and/or execution environment. For example, such arrangements may operate at least partially in a browser in a one execution environment and at least partially in a server in another execution environment interoperating via a network.

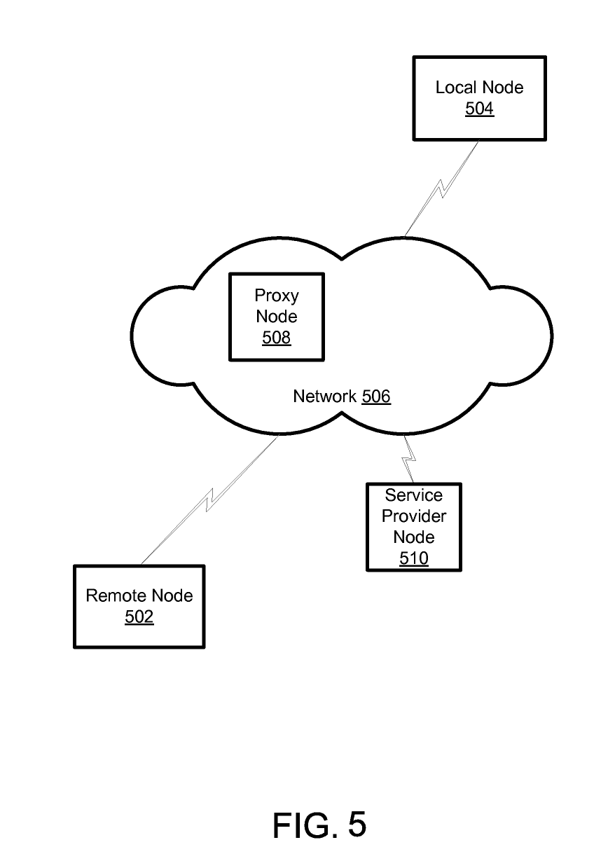

FIG. 5 illustrates a remote node 502 and a local node 504 as exemplary devices that each may be included in and/or otherwise adapted for providing an instance, adaptation, and/or analog of execution environment 401 in FIG. 4. As illustrated in FIG. 5, remote node 502 and local node 504 are operatively coupled to a network 506 via respective network interface components enabling execution environment 401 of remote node 502 and execution environment 401 of local node 504 to exchange data in a communication on behalf of communicants represented by the respective nodes.

FIG. 4 illustrates a communications agent 403 including an adaptation of the arrangement of components in FIG. 3A and an adaptation of the arrangement of components in FIG. 3B. A remote communications agent 403 may operate, in execution environment 401 of remote node 502, on behalf of a remote communicant to communicate with a local communicant represented by a local communications agent 403 operating in execution environment 401 of local node 504.

An execution environment 401 is illustrated in FIG. 4 hosting communications agent 403. Components in FIG. 4 are referenced for illustrative purposes in describing operations performed in an execution environment of remote node 502 and an operations performed execution environment 401 of local node 504. Exemplary communications agents include email clients, phone clients including Voice over Internet Protocol (VoIP) clients, instant messaging clients, short message service (SMS) clients, multimedia message service (MMS clients), multi-media communications clients including video phone clients, and other data transfer agents.

Communications agents 403 such as illustrated in FIG. 4, respectively operating in execution environment 401 of remote node 502 and in execution environment 401 of local node 504 in FIG. 5 may interoperate via respective network stacks 405. Communications agents 403 may communicate via one or more communications protocols. FIG. 4 illustrates communications protocol component 407 exemplifying a subsystem for exchanging data via network 506 according to one or more communications protocols, such as simple mail transfer protocol (SMTP), an instant messaging protocol, and/or a real-time voice and/or video protocol. A communication between communications agents 403 in execution environment 401 of remote node 502 and execution environment 401 of local node 504 may include more than one type of data and may use one or more communications protocols in exchanging one or more types of data via network 506.

Instances, adaptations, and/or analogs of communications agent 403 in FIG. 4, in execution environment 401 of remote node 502 and in execution environment 401 of local node 504, respectively, may communicate via discrete messages, a request/reply protocol, a data streaming protocol, a session and/or connection-oriented protocol, a connectionless protocol, a real-time communications protocol, an asynchronous communication, a store and forward communications protocol, a reliable delivery communications protocol, a best-effort delivery communications protocol, and/or a secure protocol, to name a few communications options.

FIG. 4 illustrates communications agent 403 including a content manager component 409. Content manager component 409 may interoperate with communications protocol layer component 407 and/or network stack 405 to receive data in one or more communications via network 506 with another communications agent in another execution environment. Content manager component 409, in FIG. 4, is operatively coupled, via com-in component 411, to communications protocol component 407 and operates to receive the data from the other execution environment.

Data received in a communication may include one or more data portions having respective content types. Exemplary content types include plain text, markup such as hypertext markup language (HTML), audio data, image data, and/or executable data. Executable data may include script instruction(s), byte code, and/or machine code. In FIG. 4, communications agent 403 includes one or more content handler components 413 to process data received according to its content type. A data type may be identified by a MIME type identifier. Exemplary content handler components 413 include text/html content handler components for processing HTML representations; application/xmpp-xml content handler components for processing extensible messaging and presence protocol (XMPP) streams including presence tuples, instant messages, and audio content handlers including and/or configured to retrieve suitable codices; video content handler components for processing video representations of various types; and still image data content handler components for processing various image data representations.

Content handler component(s) 413 process received data representations and may provide transformed data from the representations to one or more user interface element handler components 415. One or more user interface element handler components 415 are illustrated in a presentation controller component 417 in FIG. 4. Presentation controller component 417 may manage visual, audio, and other types of output for its including application as well as receive and route detected user and other inputs to components and extensions of its including application, communications agent 403. A user interface element handler component 415 may be adapted to operate at least partially in a content handler component 413 such as a text/html content handler component and/or a script content handler component. Additionally or alternatively, a user interface element handler component in an execution environment 401 may be received via a network in one or more data packets or messages of a network protocol, which in some aspects may be a communications protocol. For example, a communication, such as an email, may include an HTML content type portion and a script content type portion.

FIGS. 6A-G illustrate various user interfaces, some of which include window UI elements 602 presentable in a presentation space of a display device, such as output device 130 in FIG. 1. A window UI element 602 may include a sending communicant UI element 604 for presenting an identifier of a communicant in the role of a sending communicant in a communication represented by the window UI element 602. A window UI element 602 may also include a recipient communicant UI element 606 for presenting one or more recipient communicant identifier(s) identifying one or more communicants in the role of recipient communicant(s) in the communication. A presentation space 608 may be included in each window UI element 602 for presenting a communicant message UI element 610 that may present a communicant message from one user to another. A presentation space 608 may also be provided for presenting one or more UI elements that correspond to user inputs for exchanging data in and/or otherwise managing a communication.

Data to send in a communication to a communications agent in execution environment 401 of local node 504 may be received by one or more content handler component(s) 413 operating in execution environment 401 of remote node 502 to transform the data into one or more data representations suitable for transmitting in the communication and/or suitable for processing by the communications agent in execution environment 401 of local node 504. The one or more data representations may be provided to content manager component 409 for sending in the communication to execution environment 401 of local node 504. Content manager component 409 may package and/or otherwise prepare for packaging the one or more data representations in a message formatted according to a communications protocol of the communications agent. Communications protocol component 407 may send the data according to the specification(s) of the communications protocol. Content manager component 409 may alternatively or additionally encode and/or otherwise transform one or more of the data representations so that the data may be sent in a data stream such as voice stream and/or a video stream in the communication to a communications agent via a network.

Content manager component 409 operating in execution environment 401 included in and/or otherwise provided by a node, such as execution environment 401 of remote node 502, may provide the packaged, encoded, and/or transformed data to communications protocol component 407 via a com-out component 419. Com-out component 419 as described above operatively couples communications agent 409 to communications protocol component 407 according to an interface provided by communications protocol component 407 to send data in a communication according to a communications protocol. Communications protocol component 407 may further package and/or otherwise transform the data to send via network stack 405 for delivery via network 506 to another node, such as local node 504.

As described above, a communications protocol may operate via one or more nodes in a network in a network path communicatively coupling a remote node and a local node. Exemplary path nodes include mail relay nodes, phone switch nodes, and proxy nodes such as instant messaging proxies for communicating through firewalls. As indicated, proxy node 508 may operate as a path node.

A recipient communicant is identified for sending data in a communication. A recipient communicant may be represented and/or otherwise identified by a communications address in an address space of a communications protocol. In one aspect, information identifying a communications address may be received from a communicant of a communications agent in an execution environment. In FIG. 4, presentation controller 417 and/or a UI element handler 415, presenting and/or managing interaction with sending communicant UI element 604a in FIG. 6A for execution environment 401 of remote node 502, may receive a sending communicant alias in response to a user input corresponding to UI element handler 415. The user/communicant of execution environment 401 of remote node 502 may enter a sending communicant alias, such as “William”, via a keyboard and/or select a predefined communicant alias presented in a selection UI control element via a UI element handler component 415. The user input may be detected by input driver 421. Corresponding input information may be routed to presentation controller 417 by GUI subsystem 423. GUI subsystem 423 operates to send presentation information to a display device via a graphics subsystem 425. Communication agent 403 may identify a communication address associated with the sending communicant alias, “William”. Other communications address, such as for one or more recipient communicants, may be received similarly and/or in any suitable manner. In an aspect, one or more sending communicant and/or recipient communicant identifiers may be determined automatically.

Data may be sent in a communication according to a form or type of the communication and/or other attribute of the communication such as a security attribute, the amount of data to be set, a priority setting, a task setting, and the like. Some forms of communication do not require a session and/or a protocol connection between nodes representing communicants in the communication in order to send data between and/or among the nodes, while other forms of communication do. An email and/or instant message may use a store and forward model of delivery.

Data may be sent in a communication in response to a communicant input. In FIG. 6A a sending communicant may provide an input corresponding to reply UI element 612a in FIG. 6A. The input may be received by presentation controller component 417 and/or one or more UI element handlers 415 corresponding to reply UI element 612a. In response to detecting the input, presentation controller component 417 may provide data to be sent in the communication to one or more content handler components 413 according to the content type(s) of the data to be sent.

The one or more content handler components 413 may encode, format, and/or otherwise transform the data for sending in a message, such as an email message. The one or more content handler components 413 may provide data to be sent to content manager 409, instructing content manager component 409 to send the data in the communication for delivery to a communications agent in execution environment 401 of local node 504. Content manager component 409 interoperating with com-out component 419 may further format and/or transform the data for sending in the communication according to a communications protocol, for example according to an email communications protocol, by communications protocol component 407. Communications protocol component 407 may send the data in a data unit of the communications protocol for delivery to the communications agent in execution environment 401 of local node 504 via network 506.

One or more path nodes may relay data sent in the communication between execution environment 401 of remote node 502 and execution environment 401 of local node 504. A path node may determine a next node and/or a network interface in a network path communicatively coupling execution environment 401 of remote node 502 and execution environment 401 of local node 504 for exchanging data in a communication between communication agents 403 in the respective execution environments 401 of remote node 502 and local node 504.

For session-oriented and/or connection-oriented communication a session and/or connection may be established if a session/connection has not already been established. Data may be sent for delivery to a communications agent identified based on a recipient communicant communications address during session and/or connection setup. For example, for a voice communication a voice communication may be established via a session initiation protocol (SIP) based on a phone number and/or user identifier of the called party. Communications protocol component 407 may operate according to the session initiation protocol specifications. Communications protocol component 407 operating in execution environment 401 of execution environment 401 of remote node 502 may locate a communications agent by communicating with one or more nodes in network 506 according to the session initiation protocol. Communications protocol component 407 may locate a communications agent in execution environment 401 of local node 504, based on a communications address for the recipient communicant.

Once a communication session is established, such as a voice session, data may be sent according to the session communications protocol, such as RTP. Data may be sent according to the session initiation protocol in the communication for managing the voice communication session and/or for exchanging text, image, and/or other data outside of the voice session. One or more path nodes may be included in session and/or connection setup. Alternatively or additionally, one or more path nodes may be included in a network path in a session and/or connection.

With reference to FIG. 2A, a block 202 illustrates that the method includes identifying, by a local communications agent in a local execution environment, data as a view descriptor, wherein the data is received by the local communications agent in a communication, via a network, with an other communications agent in an other execution environment, wherein the view descriptor is identified for accessing presentation data representing remote presentation information sent by a remote component operating in a remote execution environment for representing in a first presentation space in the remote execution environment. Accordingly, a system for exchanging presentation data based on a communication includes means for identifying, by a local communications agent in a local execution environment, data as a view descriptor, wherein the data is received by the local communications agent in a communication, via a network, with an other communications agent in an other execution environment, wherein the view descriptor is identified for accessing presentation data representing remote presentation information sent by a remote component operating in a remote execution environment for representing in a first presentation space in the remote execution environment. For example, the arrangement in FIG. 3A, includes descriptor handler component 302 that is operable for identifying, by a local communications agent in a local execution environment, data as a view descriptor, wherein the data is received by the local communications agent in a communication, via a network, with an other communications agent in an other execution environment, wherein the view descriptor is identified for accessing presentation data representing remote presentation information sent by a remote component operating in a remote execution environment for representing in a first presentation space in the remote execution environment. FIG. 4 illustrates descriptor handler component 402 as an adaptation and/or analog of the descriptor handler component 302 in FIG. 3A. One or more descriptor handler components 402 operate in an execution environment 401. The system for exchanging presentation data based on a communication includes one or more processors and logic encoded in one or more tangible media for execution by the one or more processors that when executed is operable for identifying, by a local communications agent in a local execution environment, data as a view descriptor, wherein the data is received by the local communications agent in a communication, via a network, with an other communications agent in an other execution environment, wherein the view descriptor is identified for accessing presentation data representing remote presentation information sent by a remote component operating in a remote execution environment for representing in a first presentation space in the remote execution environment.

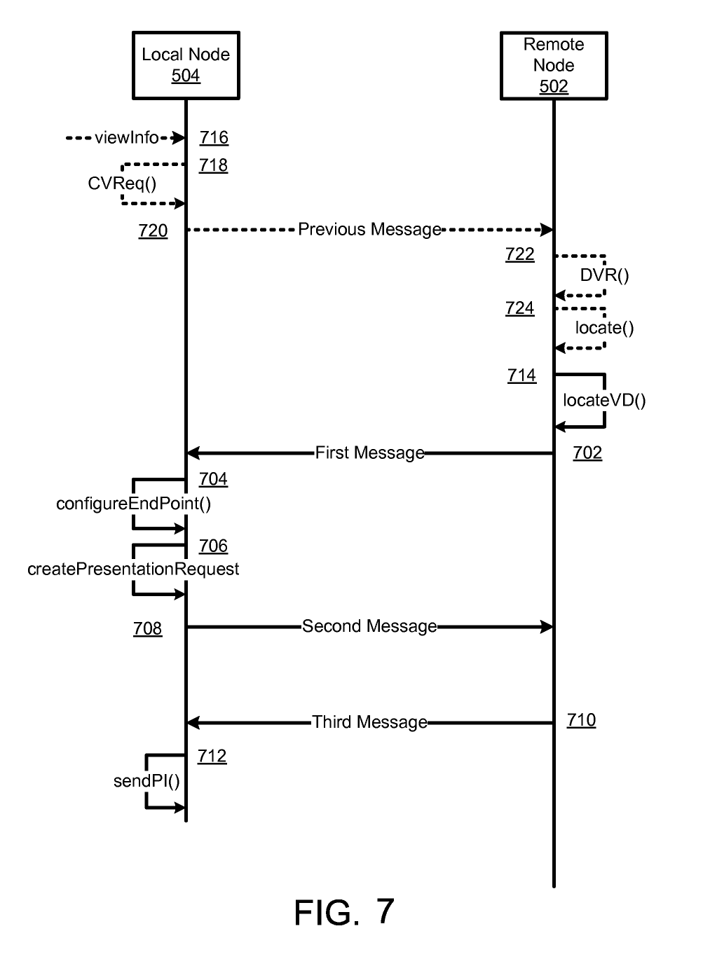

FIG. 7 includes a data flow message that illustrates a first message 702, including a view descriptor, received via network 506 by execution environment 401 including and/or otherwise provided by local node 504. First message 702 is sent via a communications protocol by a communications agent 403 in execution environment 401 including and/or otherwise provided by remote node 502.

First message 702 may be addressed to a user of execution environment 401 of local node 504 by a communications address, that identifies the user, from an address space of the communications protocol. First message 702 may be from a user, identified by a communications address in the address space of the communications protocol and represented by communications agent 403 in execution environment 401 of remote node 502. The communications protocol may include a protocol specified for exchanging at least one of an email, an instant message, a short messaging service message (SMS), a multi-media message (MMS), an audio message, a video message, and an attachment. First message 702 may include a communicant message from the user of execution environment 401 of remote node 502. Receiving first message 702 may include detecting the view descriptor in first message 702 along with the communicant message.

As described above, content manager component 409 operating in execution environment 401 of local node 504 may interoperate with communications protocol layer component 407 and/or network stack 405 to receive data in one or more communications via network 506 with another communications agent in another node. A communication may be direct and/or indirect, such via an email relay. Content manager component 409 in FIG. 4 operatively couples one or more content handler components 413 with network 506, via com-in component 411, communications protocol component 407 and/or network stack 405 to receive and process the data from the other execution environment of the other node. Thus, content manager component 409 operating in execution environment 401 of local node 504 may receive data, such as sent via first message 702, which includes a view descriptor. Content manager component 409 may provide some or all data received in first message 702 to descriptor handler component 402 to detect and/or otherwise identify a view descriptor in the data.

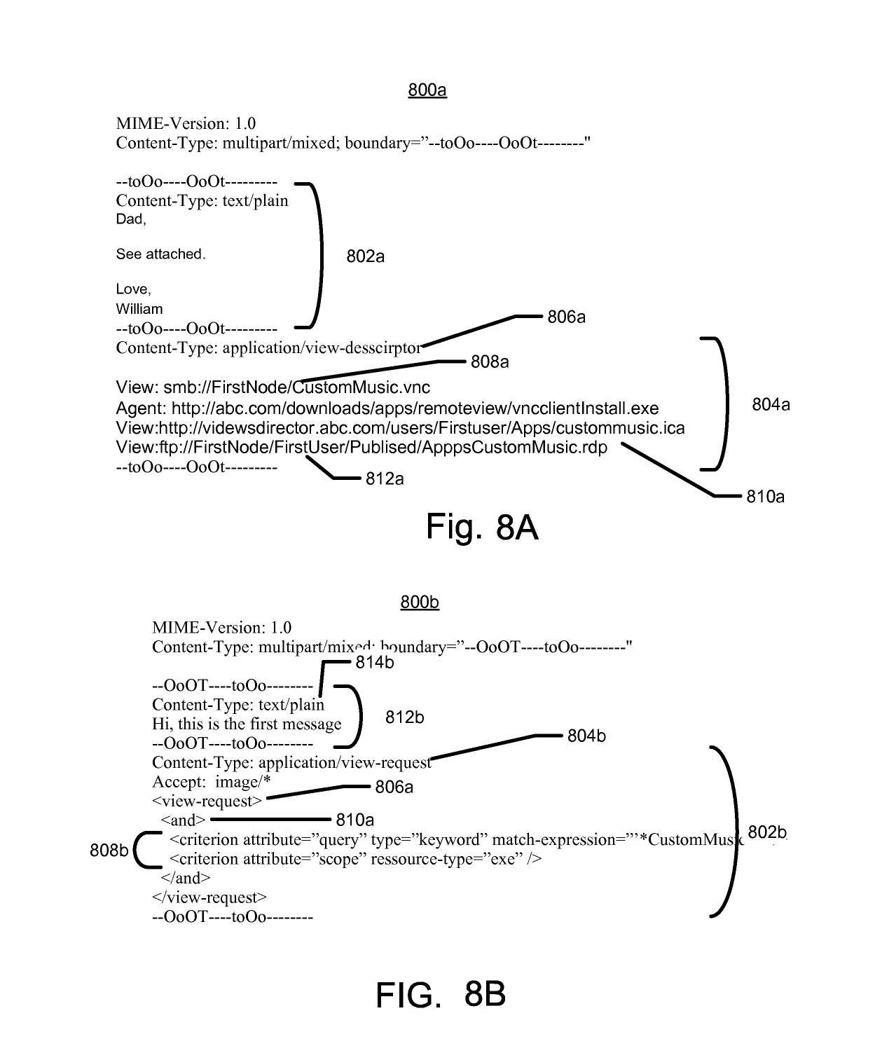

FIG. 8A includes an exemplary content portion 800a of an email message. Content portion 800a includes a communicant message portion 802a and a view descriptor portion 804a described in more detail below. The received communication may include a communicant message addressed to a user represented by communications agent 403 in execution environment 401 of local node 504. In FIG. 8A the view descriptor detectable by a descriptor handler component based on a MIME type identifier 806 defined to identify a bounded portion of the content portion 800a as a view descriptor portion 804a. View descriptor a portion 804a may identify one or more view profiles and/or configuration data for one or more view profiles. A view profile enables access to a view source. In FIG. 8A, one or more view sources for access a user interface of a “CustomMusic” application are identified. “CustomMusic” application operates, at least in part, in execution environment of remote node 502. In FIG. 8A a number of view profile are identified by respective URLs. One or more of the profiles may be stored in a data store of the execution environment of the remote node 502 and/or may be accessible via another node and/or execution environment. Identifiers other than URL's may be included in a view descriptor. For examples, an identifier may be included that is in an address space of the execution environment of the remote node 502, but is not in an address space of the execution environment of the local node 504. Alternatively or additionally, one or more profiles or portions thereof may be included in a view descriptor. Profile specifications for VNC, RDP, and ICA are publicly available as are those for other remote viewing systems.

A view descriptor may identify, as does a VNC profile, a protocol for accessing a desktop and/or application user interface, a protocol version, a security type and whether security is negotiable, authentication information, whether access is shared or exclusive, whether access is view only, the dimensions of the presentation space to present, pixel format, pixel encodings, a name or identifier of the view or desktop, application, or user interface element, whether the session will support request/reply and/or asynchronous exchanges, an input event map, whether cut and paste is supported, and a color map.

A view descriptor may identify, as does an ICA profile, a name of a connection or published application, network connection attributes (e.g., transport protocol, protocol address, ICA protocol version), authentication information, a path of an initial program, a working directory, input device attributes, screen size, firewall attributes when local and remote execution environments are separated by a firewall, client attributes (e.g., client operation system information), and encryption information, among other things.

A configure end point data flow 704, illustrated in FIG. 7, may be internal to execution environment 401 of local node 504 and/or that may include a message received via network 506 by local node 504. Configure end point data flow 704 may correspond to a data exchange for detecting a view descriptor. In an aspect, such a data flow 704 may include a data exchange with descriptor handler component (DH) 402 operating in execution environment 401 of local node 504. A view descriptor may be identified to and/or otherwise provided to descriptor handler component 402. Content handler component 409, operating as described with respect to block 202 of FIG. 2A, may identify and/or otherwise provide a view descriptor to a descriptor handler component 402.

Content manager component 409 may provide some or all of the data in a received data, such as data received in first message 702, to descriptor handler component 402. Descriptor handler component 402 may identify and/or otherwise detect a view descriptor in the data sent from the execution environment 401 of remote node 502. Content manager component 409 may interoperate with descriptor handler component 402 in identifying the view descriptor. The view descriptor may be identified for processing by descriptor handler component 402 by content manager component 409 according to a schema for the data. For example, a portion of an email message may include a MIME-type identifier that identifies a corresponding part of the email as a view descriptor and/or otherwise identifies the part for routing to descriptor handler component 402 in communications agent 403 in execution environment 401 of local node 504

A view descriptor may be sent from an sending execution environment and received by a local execution environment in a communication that includes an exchange via the network between the sending execution environment and the local execution environment of at least one of video communicant message, an audio communicant message data, and text communication message input by and/or otherwise received via interaction with at least one of the local user and a user represented by a communications agent in the sending execution environment via at least one of first communications protocol by which the view descriptor is sent and received and/or via a second communication protocol.

In an aspect, receiving a view descriptor may include receiving, by a local execution environment, view information, identifying an matching criterion, from a local user represented by a local communications agent in the local execution environment. A view request may be sent by the local communications agent and/or other component of the local execution environment to another communications agent via a network. The view request may be constructed and/or otherwise identified based on the matching criterion. The view request may be sent via a communication protocol based on a communications address that identifies a user represented by the other communications agent. The view request may be sent in a previous data unit or previous message of the communications protocol. In response to sending the previous message, the local communications agent may receive a view descriptor. The view request may include match information based on the matching criterion for locating and/or otherwise identifying a presentation space, a UI element, a component presenting and/or capable of sending presentation information to present data in a presentation space of hosting execution environment, and/or any other view source. With respect to FIG. 4 and FIG. 5, execution environment 401 of local node 504 may request a view descriptor from execution environment 401 of remote node 502. FIG. 7 includes a data flow message that illustrates a view information data flow 716 that may occur at least partially in execution environment 401 of local node 504 and/or may include a message (not shown) received via network 506 by execution environment 401 of local node 504. View information data flow 716 may represent, in FIG. 4, a data flow to a view request constructor (VRC) component 433 operating in execution environment 401 of local node 504. The data flow may be via communications agent 403.

Receiving view information may include receiving a message, identifying the view information, via a network from an execution environment that received the view information from a user. In various aspects, VRC component 433 may receive view information from a user via one or more UI element handler components 415. The view information may be received, in response to a user input detected by an input device of an execution environment 401 that includes the VRC component 433 Alternatively or additionally, view information may be received by a VRC component in a message received via a network. For example, a user may identify view information to a browser operating in a client node. The browser may send the view information via a network communicatively coupling the client node to a web service provider node. The web service provider node may include a VRC component that may operate to receive the view information identified in the message from the browser. In another aspect, an VRC component may be provided in whole or in part by execution environment 401 of node 504 to a browser in another execution environment.

FIG. 6E illustrates an exemplary user interface that may be presented by communications agent 403 operating in execution environment 401 of local node 504. A UI element handler component 415 may operate to present a user interface element to allow a user to identify view information. A view request UI element 656e is illustrated in FIG. 6E as an example. The same or different UI element handler component 415 may present various other UI elements included in view request UI element 656e. View request UI element 656e and one or more UI elements it includes may be presented by one or more corresponding UI element handler component(s) 415 that may operate based on a schema that defines valid view information and/or valid view requests for including in a communication by a communications agent 403. The schema defines one or more rules and/or a vocabulary that defines whether view information and/or a view request is valid. Those skilled in the art will understand that numerous languages and/or schemas for providing view information and/or view requests currently exist including relatively simple key word based queries to relatively more complicated regular expression languages and data base query languages, such as various versions of structured query language (SQL). New schemas are and will be created, and are, thus, considered within the scope of the subject matter described herein.

View request UI element 656e illustrates a user interface for a keyword based schema. Match textbox UI element 658e illustrates a textbox allowing a user to enter a keyword expression. Various checkbox UI elements 660e allow a user to define a scope of a view request by identifying whether a resulting view request is to be applied to folders, files, and/or output devices in a remote execution environment. A communications agent 403 may support more than one view request schema and/or corresponding view information schema. A communications agent may provide a user interface to receive valid view information for each respective schema.

View information and/or a view request may be generated, detected, and/or otherwise processed according to a schema that identifies at least one of a rule and a vocabulary that defines a valid view request. Similarly, a view descriptor may be generated, detected, and/or otherwise processed according to a schema. One or more schemas may alone or together define one or more of valid view information, a view request, and/or a view descriptor. A schema, as just described, may be identified based on a data received and/or otherwise identified by an execution environment hosting a communications agent via the network from another execution environment hosting communications agent and/or from a path node included in a network path in the network communicatively coupling the node to one or more nodes that respectively host a communications agent.

In a further aspect, multiple alternative schemas may be defined for each of view information, view requests, and/or view descriptors. A schema may be selected and/or otherwise identified from the multiple schemas by execution environment 401 of local node 504, by the execution environment 401 of remote node 502, and/or based on information exchanged by the two nodes. For example, a schema may be selected by the local communicant and/or the remote communicant. One may inform the other, via a communications protocol and/or via any other suitable means. The communicants and/or communications agents representing the communicants may negotiate which schema to use via any suitable means.

The communications agents in execution environment 401 of remote node 502 and execution environment 401 of local node 504 may select a schema For example, a schema may be identified and/or otherwise selected based on a communications protocol supported and/or a communications protocol not supported by one or both nodes. That is, in a negotiation to select a communication protocol to use allowing communicants to exchange information, a schema may be identified. A schema may be identified and/or otherwise selected based on an attribute of a view source.

FIG. 7 includes a data flow message that illustrates a create view request (CVReq) data flow 718 that may be internal to execution environment 401 of local node 504 and/or may include a message received via network 506 by local node 504. With respect to FIG. 4, CVReq data flow 718 may illustrate a data flow to an VRC component 433 operating in execution environment 401 of local node 504. View information may be identified to and/or otherwise provided to VRC component 433.

A VRC component 433 may be a type of content handler component and/or may be included in a content handler component that operates to process view information to create a view request that conforms to a schema for creating and/or otherwise constructing a valid view request. VRC component 433 may construct and/or otherwise create a view request based on a schema that defines and/or otherwise identifies a valid view request and/or a valid view descriptor for a particular type of communication supported by a communications agent. The view request descriptor is constructed and/or otherwise created, based on the view information, by VRC component 433. VRC component 433 in execution environment 401 of local node 504 may provide the view request to content manager component 409 to include and/or otherwise identify the view request in a communication with execution environment 401 of remote node 502, such as in an email and/or an instant message. Content manager component 409 may interoperate with other types of content handler components 413 to create and/or otherwise construct a data unit and/or message of a communications protocol that includes the valid view request.

In an aspect, VRC component 433 may interoperate with the content manager component 409 to create the valid view request according to a specified schema for the message, so that the message is valid according to a communications protocol supported by a communications protocol component 407 that operates to send the message. As described above, the content manager component 409 may operate in execution environment 401 of local node 504 along with VRC component 433 to transform view information into a view request to include along with data for other parts of a communication into one or more representations suitable for transmitting in a communication, such as a message and/or data stream, to another node, such as remote node 502. Some or all of the representations transmitted are suitable for processing by the communications agent in execution environment 401 of remote node 502. The content manager component 409 in the execution environment 401 of local node 504 may package the one or more data representations including a representation of the view request into a data unit and/or message that is valid according to the communications protocol.

A VRC component and/or a content manager component may operate to construct a view request in a communication based on XQuery, regular expression, and/or SQL content, to name a few examples. A content type identifier may be included in a position and/or location that identifies a view request in a communication. The position or location may be absolute or relative. For example, a schema for a communication may define that a view request in a communication is included in the communication at the end of the communication. There may be one or more view requests at the end. In another aspect, a schema for a communication may specify that a portion of a communication following a particular type of data unit portion and/or message portion is a view request. Other view requests may follow. If no view request is included, the view request portion may include no content or may include an indicator that no view request is included.

In FIG. 8B, a portion of an email communication 800b is illustrated formatted as a multipart/mixed content type including view request portion 802b. A view request portion of a communication may be identified as a view request by its location in the communication and/or by an identifier or markup element, such as a MIME type identifier. A view request may be detected based on content included in the message and/or based on metadata such as content-type header 804b identifying a MIME type identifier, such as “application/view-request”, which may be defined for representing one or more matching criteria in a view request. The “application/view-request” MIME type identifier is exemplary. Other MIME type identifiers exist and/or may be defined to identify a view request in a communication.

A view request may be sent by a local communications agent and/or other component of a local execution environment in a previous data unit or message of a communications protocol that separately includes a communicant message from the local user as illustrated and described with respect to FIG. 8B.

A view request may be created and or modified according to a schema that identifies at least one of a rule and a vocabulary for at least one of including the view request in the previous message and identifying the view request in the previous message. FIG. 8B illustrates an “application/view-request” MIME type identifier that may be defined to identify a schema for an XML-based language for specifying view-request XML documents. FIG. 8B illustrates view-request document 806b. View-request document 806b, as illustrated, includes criterion tag elements 808b corresponding to the form elements in a user interface FIG. 6B. A criterion tag element 808b identifies a matching criterion name, such as “query” indicating that the criterion is a query expression or a portion thereof. A “type” attribute identifies a schema with the identifier “keyword” for the expression. The criterion tag element 808b identifies a value for a query “*music*” in a match-expression attribute.

A view request may identifies a scope that specifies and/or constrains what view source and may be accessed based on a view descriptor received in response to sending the view request. In FIG. 8B, another criterion tag element 808b specifies a scope query specified in the first criterion tag element. The scope illustrated may be defined to restrict matches to executable files with a “.exe” file extension. Scope may be restricted to active applications, UI elements (active or not), and or desktops, for example. FIG. 8B illustrates an “and” tag 810b indicating that all the matching criteria must be met for identifying a remote executable. An “or” tag (not shown) may be defined by a schema for view-request documents. Other operator elements and operator precedence may be defined by the schema. Grouping elements for managing operator precedence, such as parenthesis element, may be defined by the schema.

A view request may be exchanged in a communication that includes an exchange between a receiving execution environment and a local execution environment of at least one of a video communicant message, an audio communicant message data, and text communication message input by and/or otherwise received via interaction with. A view request may be included in an email, an instant message, a multi-media message, a short-message service message, and/or a data stream

A view request may be sent to a proxy execution environment operating as a proxy for a remote execution environment. In an aspect, a view request may be sent to a communications agent operating in a proxy execution environment via a communications protocol.

A view request and/or a view descriptor may be exchanged via a network by a communication protocol. The communication protocol may include a protocol for exchanging an email, an instant message, a short messaging service message (SMS), a multi-media message (MMS), an audio message, a video message, and/or an attachment. A view request and/or a view descriptor may be received a data unit or message that is valid according to a communications protocol. Either may be included in a data unit or message that includes a communicant message. In another aspect, a view request and/or view descriptor may be received in a communication via a first communications protocol and a communicant message exchanged in the communication may be exchanged via a second communications protocol. For example, communicant may be represented by communications agent that exchange audio and/or video communicant messages via a media streaming protocol such as RTP. A view request and/or a view descriptor may be exchanged via an instant message protocol, a presence protocol, and/or via a separate audio and/or video stream, which may use a protocol other different that the protocol for exchanging audio and/or video communicant messages.

Returning to FIG. 2A, a block 204 illustrates that the method further includes configuring, based on the view descriptor, a local protocol endpoint in the local execution environment. Accordingly, a system for exchanging presentation data based on a communication includes means for configuring, based on the view descriptor, a local protocol endpoint in the local execution environment. For example, the arrangement in FIG. 3A, includes access director component 304 that is operable for configuring, based on the view descriptor, a local protocol endpoint in the local execution environment. FIG. 4 illustrates access director component 404 as an adaptation and/or analog of access director component 302 in FIG. 3A. One or more access director components 404 operate in an execution environment 401. The system for exchanging presentation data based on a communication includes one or more processors and logic encoded in one or more tangible media for execution by the one or more processors that when executed is operable for configuring, based on the view descriptor, a local protocol endpoint in the local execution environment. In FIG. 4, access director component 404 is illustrated as a component of communications agent 403.

FIG. 7 includes data flow message that illustrates a configure end point data flow 704 that may be internal to execution environment 401 of local node 504 and/or that may include a message received via network 506 by execution environment 401 of local node 504. Configure end point data flow 704 illustrates a data flow to access director component 404 operating in execution environment 401 of local node 504. Access director component 404 may be invoked automatically in response to detecting a view descriptor. In another aspect, access director component 404 may be invoked in response to a user input. A network protocol endpoint may be configured in response to detecting the view descriptor and/or detecting a user input associated with the message in which the view descriptor is received.

FIG. 8A illustrates a view descriptor identifying alternative URLs for accessing the “CustomMusic” player user interface presented by a custommusic application component in execution environment 401 of remote node 502. A Samba URL 808a identifies a protocol and a location for accessing a VNC profile for accessing a user interface of the “CustomMusic” application component. Access director component 404 in execution environment 401 of local node 504 may configure a network protocol endpoint to interoperate with a Samba client (not shown) included in and/or associated with file system 402, which in an aspect may be and/or may be included in the data store of execution environment 401 of local node 504. Samba URL 808a may include user identification and authentication information to the Samba client if needed. Alternatively, the Samba client and/or access director component 404 may receive such information from the user and/or from a pre-stored profile. In an aspect, a “CustomMusic” player user interface profile, such as the VNC profile, may be stored in a desktop and/or other locate in a data store of execution environment 401 of local node 504. Configuring a protocol endpoint may include activating an endpoint of a protocol identified in one or more URLs identified in a view descriptor.

Configuring a protocol endpoint may include storing a link and/or other representation for a view profile and/or may include storing the view profile. In an aspect, more than one view profile may be stored. The view profile and/or a link to the view profile may be stored.

Configuring the protocol endpoint may include determining a view profile to process in configuring a protocol endpoint For example, a local communications agent and access director component may provide and/or otherwise identify a view profile to an access agent 406. The access agent component may interoperate with a presentation protocol component 407 to configure a protocol endpoint. The protocol endpoint may be configured to listen for data from a remote execution environment to receive presentation data from the remote execution environment. In another aspect, an access agent component may configure a presentation protocol endpoint to send a request to a remote execution environment for presentation data based on the view profile provided and/or otherwise identified by the local communications agent. In another aspect, a view descriptor may identify a representation of a some or all of a view profile that is to be removed and/or otherwise unmounted. A local execution environment may detect a view descriptor that identifies some or all of a view profile for accessing presentation data from a view source in a remote execution environment. The view profile may be removed based on the view descriptor.

In activating and/or otherwise configuring a presentation protocol endpoint, one more protocol endpoints in one or more network protocols supported by various protocol layer components in network stack 405 may be configured and/or otherwise activated. Examples of network protocol endpoints that may be configured in configuring a presentation protocol endpoint include a transport layer protocol endpoint such a TCP endpoint and/or a UDP endpoint, a network layer protocol endpoint such as an IP endpoint, and a link layer protocol endpoint such as an Ethernet protocol endpoint.

As an alternative and/or in case execution environment 401 of local node 504 does not include a Samba client and/or a compatible analog, a view descriptor may specify one or more alternatives in addition to or instead Samba. For example execution environments may be separated and/or otherwise blocked by one or more firewalls, Access director component 404 may operate to store a profile for accessing the “CustomMusic” user interface accessed via another identifier in view descriptor 804a. Hypertext Transfer Protocol (HTTP) that facilitates retrieval of view profiles stored on World Wide Web servers. An HTTP URL 810a identifies HTTP as an access protocol and identifies a location in a web server for accessing a “CustomMusic” player user interface ICA profile. Access director component 404 in execution environment 401 of local node 504 may configure an HTTP protocol endpoint to interoperate with an HTTP client in execution environment 401 of local node 504. HTTP URL 810a may include user identification and authentication information to the HTTP client if needed. Alternatively, the HTTP client and/or access director component 404 may receive authentication information from the user and/or from a pre-stored user profile. In another aspect, the “CustomMusic” player user interface viwq profile identified in the view descriptor may be stored at a location managed by second communications agent of local node 504. Alternatives to HTTP and SMB are many. FIG. 8A identifies file transfer protocol FTP as an alternative for configuring a protocol endpoint to access a view profile.

In an aspect, access director component 404 may access one or more view profiles to configure a protocol endpoint for receiving presentation data accessed via a view source in a remote execution environment. Access director component 404 may detect and/or otherwise identify some or all of a VNC profile, an RDP profile, an ICA profile, and/or an X-windows profile—to name a few examples. Access director component 404 may select one or more of the detected profiles or portions thereof to configure one or more respective protocol endpoints. In an aspect, a view profile may be selected based on an attribute of the local execution environment, such a measure of size and/or resolution of a display device of the local execution environment.

Configuring a protocol endpoint may be performed in response to representing and/or otherwise storing a view profile or portion thereof in storage location. The representing and/or storing may be performed by a communications agent that receives the view descriptor. The configuring of the protocol endpoint may, in an aspect, be performed and/or otherwise performed in response to an instruction to configure the protocol endpoint executed in the communications agent.

A protocol endpoint for receiving presentation data for a some or all of a view descriptor may be configured automatically, in response to receiving the view descriptor. For example, a user of communications agent in execution environment of local node 504 may receive an input to open a voice message, email, or other message that includes a view descriptor. The communications agent may automatically configure a protocol endpoint, in response to opening and/or otherwise receiving the message. The communications agent may interoperate with an access director component and/or an access agent component to configure one or more protocol endpoints.

Configuring a protocol endpoint based on a view descriptor may include configuring a protocol endpoint to listen for a message from an execution environment providing presentation data for presenting the some or all of a view descriptor. The protocol endpoint, may for example, be and/or may include a TCP protocol endpoint that listens for connection requests. In response, to receiving a connection request, a second protocol endpoint may be configured as an endpoint of a TCP connection for transporting presentation data. In an aspect a network layer protocol may be identified by and/or otherwise based on the view profile for configuring a network layer protocol endpoint. For example, an ICA access agent component may communicate over any of a number of transport protocols including TCP and SPX. An ICA profile may explicitly identify a transport protocol for which a protocol endpoint is to be configured. VNC, on the other hand, operates only over TCP. Thus, the network protocol for a VNC access agent component is implicitly identified.

Configuring a protocol endpoint, may include identifying an access agent component to process a view profile identified by and/or otherwise configured based on a view descriptor. The access agent component may configure a listening protocol endpoint as described above or may configure a protocol endpoint to send a message.

FIG. 7 also includes a dataflow that illustrates a create presentation request message 706 that may be internal to execution environment 401 of local node 504 and/or may include a message received via network 506 by execution environment 401 of local node 504. In create presentation request message 720 a presentation request constructor (PRC) component 431 operating in execution environment 401 of remote node.702 may be invoked to operate. A configured view profile based on a view descriptor received and/or otherwise identified in first message 702 and/or the view descriptor may be identified to and/or otherwise by PRC component 431 as part of and/or in response to being invoked. In FIG. 4, PRC component 431 is illustrated as operatively coupled to an access agent component 406 that operates to configure a protocol endpoint for sending a presentation request. Alternatively or additionally, a PRC component may be included in and/or otherwise enabled to interoperated with a communications agent or any of various other components.

FIG. 7 includes a dataflow that illustrates a second message 708, sent based on the configured protocol endpoint, that includes a presentation request to access presentation data from a view source, such as a presentation space and/or a UI element, made accessible by the view descriptor received in first message 702. FIG. 7 illustrates the presentation request is sent via network 506 by execution environment 401 of local node 504 to execution environment 401 of remote node 502.

In an aspect, second message data flow 708 in FIG. 7 may represent a message that includes a presentation request sent by the access agent component 406 in execution environment 401 of local node 504. The access agent component 406 may be invoked, directly and/or indirectly, by communications agent 403 in the local node 504. PRC component 431 may interoperate with one or both of the access agent component and/or the communications agent. In still another access, an access agent component 406 may send a presentation request in response to an input from a user defined to instruct the access agent component to send a presentation request.

In response to receiving first message 702, execution environment 401 of local node 504 may present, in a manner described above, data received in the message to a user of execution environment 401 of local node 504. FIG. 6A illustrates a view window UI element 602a as an exemplary user interface that may be presented by communications agent 403 operating in execution environment 401 of local node 504 to present data received in a communication, such as data received in first message 702, from execution environment 401 of remote node 502. FIG. 6A illustrates a sending communicant UI element 604a, a recipient communicant UI element 606a, and a presentation space 608a of the view window UI element 602a. Presentation space 608a includes a communicant message UI element 610a. The various UI elements may be presented by one or more UI element handler components 415 in communications agent 403 in execution environment 401 of local node 504. A reply UI element 612a and a reply all UI element 614a illustrate UI elements in presentation space 608a presented to allow a user of the execution environment 401 of local node 504 to respond and/or otherwise instruct execution environment 401 of local node 504 to perform an operation based on the message received in the communication. FIG. 6A illustrates an attached views UI element 616a identifying, based on the view descriptor in first message 702, a “CustomMusic” player application having a user interface accessible to execution environment of local node 504 from execution environment 401 of remote node 502.

In an aspect, configuring a protocol endpoint may include storing a view profile in a location in a data store. The view profile is identified by, included in, and/or otherwise generated based on a view descriptor. A user may be allowed to identify a location to store and/or otherwise represented the view profile. A location communications agent 403 may present a navigation UI element for navigating the data store, in response to receiving a view descriptor. The location may be determined in response to detecting a user input identifying the location. View window UI element 602a in FIG. 6A includes a configure UI element 618a for receiving user input to display a navigation window UI element 620a for identifying a location in a data store of execution environment 401 of local node 504 to save and/or otherwise attach one or more view profiles for receiving presentation data to present a user interface for the “CustomMusic” in the remote execution environment identified in the view descriptor. In response to an input directed to configure UI element 618a, a corresponding UI element handler 415 may interoperate with navigator component 429 to present navigation window UI element 620a that includes a presentation space 622a for presenting a user detectable representation of one or more locations in a data store of execution environment 401 of local node 504.

FIG. 6A illustrates a configure UI element 624a allowing a user to provide user input(s) to instruct communications agent 403 in execution environment 401 of local node 504 to request that view profile, based on the view descriptor, be represented and/or otherwise stored at a location, identified in navigation window UI element 602b, in the data store in execution environment 401 of local node 504. Navigation window UI element 620a illustrates a “Desktop” folder in which a view profile identified by the view descriptor may be represented and/or otherwise stored.

In another aspect, desktops, user interfaces, UI elements, and other view sources identified and/or otherwise accessible via a view descriptor may be illustrated in a manner similar to attachments rather than in a separate UI element as in FIG. 6A. Representing and/storing a view profile, based on a view descriptor, to access a view source may include receiving an indication by a communications agent to access presentation data via the view descriptor. In response, a location in a data store for representing and/or otherwise storing a view profile based on the view descriptor may be determined automatically. Further, in response to receiving the indication the view profile may be represented and/or otherwise stored automatically at the location. Still further, in response to receiving the indication, the presentation data may be accessed via the network via the view profile based on the view descriptor as described above. The view profile may include and/or otherwise identify, for example, a VNC profile and/or Remote Desktop Connection profile.

In response to detecting the view descriptor in first message 702, execution environment 401 of local node 504 may present a view window UI element 602b in FIG. 6B including data received in the first message 702 to a user of execution environment 401 of local node 504 as described with respect to FIG. 6A. Context menu 626b provides UI elements to allow the user to instruct execution environment 401 of local node 504 to retrieve and/or otherwise receive, in response to an input corresponding to “View” menu UI element 626b2, presentation data via a view descriptor received from execution environment 401 of remote node 502. Context menu 626b provides a store UI element 626b1 to allow the user to instruct execution environment 401 of local node 504 to represent and/or otherwise store a view profile based on the view descriptor at a location in the data store of execution environment 401 of local node 504.

Alternatively or additionally, a location for representing and/or otherwise storing a view profile based on a view descriptor may be determined by detecting user input included in performing a drag and drop operation on a representation of the some or all of the view descriptor presented via an output device. The drag and drop operation may be performed to represent and/or otherwise store the view profile based on the received view descriptor at a location in a data store. FIG. 6B includes a pointer UI element 628b dragging a representation of the “CustomMusic” player view descriptor from attached views UI element 630b in view window UI element 602b. The representation of the “CustomMusic” player view descriptor is shown over a desktop UI element 634b to identify a location in the desktop of execution environment 401 of local node 504.

In another aspect, a presentation request, described below, may be sent in response to dragging and dropping view descriptor on a desktop or other UI element to present a presentation data from a view source identified in the presentation request based on a view descriptor operated on by the drag and drop operation.

Returning to view UI element 626b2 in FIG. 6B, a corresponding UI element handler component 415 in local communications agent 403 in environment 401 of local node 504 may invoke PRC component 431 to construct a presentation request to retrieve presentation data based on the view descriptor in response to an user input corresponding to the view UI element 626b2. The PRC component 431 and/or the local communication agent 403 may interoperate with access agent component 406 via access director component 404 to configure a presentation protocol endpoint. The access director component 404 may retrieve, identify, and/or otherwise may generate a view profile, such as VNC profile based on the view descriptor. Access agent component 404 may invoke a suitable access agent component 406 based on the view profile, such as VNC client.

FIG. 6C illustrates another exemplary user interface that execution environment 401 of local node 504 may present to the user to allow the user to instruct execution environment 401 of local node 504 to construct and send a presentation request in a message. A protocol endpoint is configured in order to send the presentation request. View window 602c may be presented in response to a view descriptor received in a communication without a communicant message. Rather than a UI element for displaying a communicant message, a remote views pane UI element 638c may be presented that identifies some or all view descriptors available from execution environment 401 of remote node 502. The view descriptor may be received without a communicant message as FIG. 6C illustrates or may be received with a pre-written and/or automatically generated message. Open UI element 634c may be presented by execution environment 401 of local node 502 to allow the user of execution environment 401 of local node 502 to request the retrieval of presentation data accessible via a view descriptor identified in remote views pane 638c.

In an aspect, second message data flow 708 in FIG. 7 may represent a message that includes a presentation request sent by the local communications access agent component 403 in execution environment 401 of local node 504.

A presentation request may be sent in a message via the protocol endpoint, of a communications protocol of a communications agent 403. As described above, content manager component 409 in execution environment 401 of local node 502 may package the one or more data representations including a representation of a presentation request into a message and/or data unit of a communications protocol in a communication. The message is formatted according to the communications protocol supported by communication agent 403 in execution environment 401 of local node 504. Communications protocol component 407 operating in execution environment 401 of local node 504 may send the data unit and/or message according to the specification(s) of the communications protocol. Content manager component 409 may alternatively or additionally encode and/or otherwise transform one or more of the data representations for sending in a data stream such as voice stream and/or a video stream for communicating in a communication.

Content manager component 409 operating in execution environment 401 included in and/or otherwise provided by local node 504 may provide the packaged, encoded, and/or transformed data to communications protocol component 407 via a com-out component 419. Com-out component 419 as described above operatively couples communications agent 409 to communications protocol component 407 according to an interface provided by communications protocol component 407 to send data in a communication according to a communications protocol. Communications protocol component 407 may further package and/or otherwise transform the data to send via network stack 405 for delivery via network 506 to execution environment 401 of remote node 504.

In an aspect, when a suitable access agent component is not located in a viewing execution environment by an access director component, a suitable access agent component may be retrieved based on agent information identified by a view descriptor. That is, configuring a protocol endpoint may include detecting that an access agent component is not present in a local execution environment. The access agent component may be retrieved by and/or at the direction of the access director component via the network based on the view descriptor. A protocol endpoint may be configured based on and/or otherwise in response to retrieving the access agent.

A presentation request may be sent to a remote execution environment that hosts the component and/or application that generates the user interface presentation information. In another aspect, a presentation request may be sent to a proxy for the remote execution environment that hosts the component and/or application that generates the user interface presentation information

A presentation request may include at least one of authentication information and authorization information. The authentication information and authorization information may be determined and/or otherwise identified based on the view descriptor.

Returning to FIG. 2A, a block 206 illustrates that the method yet further includes receiving, by the local execution environment and based on the local protocol endpoint, the presentation data. Accordingly, a system for exchanging presentation data based on a communication includes means for receiving, by the local execution environment and based on the local protocol endpoint, the presentation data. For example, the arrangement in FIG. 3A, includes access agent component 306 that is operable for receiving, by the local execution environment and based on the local protocol endpoint, the presentation data. FIG. 4 illustrate access agent components 406 as an adaptations and/or analogs of access agent component 306 in FIG. 3A. One or more access agent components 406 operate in an execution environment 401. The system for exchanging presentation data based on a communication includes one or more processors and logic encoded in one or more tangible media for execution by the one or more processors that when executed is operable for receiving, by the local execution environment and based on the local protocol endpoint, the presentation data. In FIG. 4, a access agent component 406 is illustrated as a component of application 403.

FIG. 7 includes a dataflow that illustrates a third message 710 transmitted via network 506 by execution environment 401 of remote node 502 to execution environment 401 of local node 504. The presentation data may be received in response to sending the presentation request in second message 708. In another aspect, presentation data may be sent asynchronously to a local node without the local node sending a request.

As described above, content manager component 409 operating in execution environment 401 of local node 504 may interoperate with communications protocol component 407 and/or network stack 405 to receive data in a communication, via network 506, with another communications agent in another node. Content manager component 409 is operatively coupled, via com-in component 411, to communications protocol component 407 to receive the presentation data from the other node. Thus, execution environment 401 of local node 504 may receive a message in a communication with execution environment 401 of remote node 502 via a com-in component 411. The message includes presentation data. The message may be received in response to sending a presentation request. Content director component 410 may be included in content manager component 409 to detect one or more portions of a received message, such as a portion that is a response to a presentation request. Content director component 410 may invoke one or more content handler components 413 to process one or more data objects provided in the message according to their type.

In another aspect, presentation data may be received by an access agent component 406 in execution environment 401 of local node 504. Thus, the dataflow illustrated by third message 718 may be a message received by a VNC client, an ICA client, an RDP client, and/or other access agent component type operating in execution environment 401 of local node 504. Such clients/agents are illustrated in FIG. 4 by access agent component 406.

Either or both of second message 708 and/or third message 710 may be exchanged via a presentation protocol suitable for an access agent component, access server pair. Protocols such a VNC protocol, an ICA protocol, an RDP protocol, X-windows, and/or other presentation protocols have been identified and discussed above. A presentation protocol component 407 is illustrated in FIG. 4 as a component that operates according the specification(s) of one or more remote view protocols. Presentation protocols may be exchanged between nodes on a LAN or communicatively coupled by a point-to-point link via a link layer protocol. Nodes such as nodes on the Internet that are communicatively coupled via multiple networks may exchange presentation protocol data units and/or messages via a network layer protocol such as the Internet Protocol (IP). Such nodes typically use a transport layer protocol, such as UDP and/or TCP to exchange presentation protocol data.

Presentation data, in various aspects may include image data, frame buffer data, image vector data, pixel data, markup in a markup language, and/or a graphics command. The type of data received may depend on a presentation protocol by which the presentation data is exchanged. Presentation data may be accessed via and/or otherwise represent data in a presentation space of a remote execution environment, presentation information sent by a component operating in a remote execution environment, data identifying a command and input data to be processed by the command in the local execution environment that duplicates and/or replaces a corresponding command processing corresponding data in a remote execution environment, and/or data from another view source. The component operating in the remote execution environment may operate to present a desktop for a user of the remote execution environment. The desktop may be represented by presentation data.

Returning to FIG. 2A, a block 208 illustrates that the method yet further includes sending local presentation information, based on the presentation data, to present a representation of the remote presentation information via an output device of the local execution environment. Accordingly, a system for exchanging presentation data based on a communication includes means for sending local presentation information, based on the presentation data, to present a representation of the remote presentation information via an output device of the local execution environment. For example, the arrangement in FIG. 3A, includes local view manager component 308 that is operable for sending local presentation information, based on the presentation data, to present a representation of the remote presentation information via an output device of the local execution environment. FIG. 4 illustrates local view manager component 408 as an adaptation and/or analog of local view manager component 308 in FIG. 3A. One or more local view manager components 408 operate in an execution environment 401. The system for exchanging presentation data based on a communication includes one or more processors and logic encoded in one or more tangible media for execution by the one or more processors that when executed is operable for sending local presentation information, based on the presentation data, to present a representation of the remote presentation information via an output device of the local execution environment.

A send presentation information (send PI) data flow 712, illustrated in FIG. 7, may be internal to execution environment 401 of local node 504 and/or may include a message exchanged via network 506 by local node 504. Send PI data flow 712 may correspond to a data exchange for sending presentation information based on the presentation data received via third message 710. In an aspect, a send presentation information data flow 712 may include a data exchange with local view manager component 408 operating in execution environment 401 of local node 504. The presentation data received in third message 710 and/or presentation information based on the presentation data may be identified to and/or otherwise provided to local view manager component 408. The third message may be and/or may be included in one or more data units of a presentation protocol supported by presentation protocol component 407. Presentation protocol component 407 may receive the third message via network stack 405. An access agent component 406 may receive the presentation data from presentation protocol component 407. Access agent component 406 may identify and/or otherwise provide the presentation data and/or presentation information based on the presentation data to access director component 404. Access director component 404 may identify a presentation space in local execution environment and/or otherwise may identify a UI element in which the presentation data is to be represented. Access director component may provide and/or otherwise identify the presentation space to local view manager component 408.

Local view manager component 408 may interoperate with GUI subsystem 423 to instruct GUI subsystem 423 to interoperate with a display device driver and/or a graphics subsystem 425 to send presentation information to a display device via graphics subsystem 425 to present a local representation of remote presentation information generated by a component of execution environment 401 of remote node 502. The local presentation information is based on the received presentation data. The local representation may be presented in a presentation space of a display device of execution environment of local node 504. In an aspect, local view manager component 408 may generate local presentation information based on the presentation data and represent the local presentation information in a presentation space in and/or otherwise accessible to local view manager component 408. Local view manager component 408 may provide data from the presentation space as local presentation information to GUI subsystem 432 to present a representation of the remote presentation information generated by the remote execution environment that the presentation data includes and/or otherwise represents

In an aspect local presentation information may be presented as the remote execution environment presents the corresponding remote presentation information. The local user and the remote user may, thus, share a desktop, an application user interface, and/or a UI element.

With reference to FIG. 2B, a block 212 illustrates that the method includes receiving, by a remote communications agent in a remote execution environment, descriptor information for identifying presentation data representing remote presentation information, sent by a remote component operating in the remote execution environment, to be represented in a first presentation space in the remote execution environment. Accordingly, a system for exchanging presentation data based on a communication includes means for receiving, by a remote communications agent in a remote execution environment, descriptor information for identifying presentation data representing remote presentation information, sent by a remote component operating in the remote execution environment, to be represented in a first presentation space in the remote execution environment. For example, the arrangement in FIG. 3B, includes remote view manager component 312 that is operable for receiving, by a remote communications agent in a remote execution environment, descriptor information for identifying presentation data representing remote presentation information, sent by a remote component operating in the remote execution environment, to be represented in a first presentation space in the remote execution environment. FIG. 4 illustrates remote view manager component 412 as an adaptation and/or analog of remote view manager component 312 in FIG. 3B. One or more remote view manager components 412 operate in an execution environment 401. The system for exchanging presentation data based on a communication includes one or more processors and logic encoded in one or more tangible media for execution by the one or more processors that when executed is operable for receiving, by a remote communications agent in a remote execution environment, descriptor information for identifying presentation data representing remote presentation information, sent by a remote component operating in the remote execution environment, to be represented in a first presentation space in the remote execution environment. In FIG. 4, a remote view manager component 412 is illustrated as a component of communications agent 403.

FIG. 7 includes data flow message that illustrates a locate view descriptor (locateVD) data flow 714 data flow to locate, locate and/or otherwise construct a view descriptor that identifies a presentation space, an UI element, a component that is capable of presenting a user interface to a user via an output device of executable environment of remote node 502, and/or any other suitable view source. Locate view descriptor data flow 714 in FIG. 7 may, in FIG. 4, represent communications agent 403 providing and/or otherwise identifying descriptor information to remote view manager component 412 to process in creating and/or locating a view descriptor. Locate view descriptor data flow 714 may be internal to execution environment 401 of remote node 502 and/or may include interoperation by execution environment 401 of remote node 502 via a network with another node.

FIG. 6D, illustrates an edit window UI element 602d that, in an aspect, may be presented by communication agent 403 in execution environment 401 of remote node 502 in response to a user input to create a new email or other type of data exchange in a communication. In an aspect, a user of communications agent 403 operating in execution environment 401 of remote node 502 may provide input corresponding to share view UI element 640d in edit window UI element 602d. A corresponding UI element handler component 415 may operate to invoke navigator component 429 to present a navigation window UI element (not shown) to locate one or more view sources in response to user interaction. Data store navigation component 429 may interoperate with one or more UI element handlers 415 in communications agent 403, directly or indirectly to present the navigation window UI element and its contents.

Navigation window UI element may be presented to identify and/or otherwise receive descriptor information in response to user input to identify a view source to remote view manager component 412. A folder content pane UI element may be presented in navigation window UI element including representations of one or more presentation spaces, UI elements, components is capable of presenting a user interface to a user via an output device of executable environment of remote node 502, and/or other view sources.

In FIG. 6D, a pointer UI element 642d illustrates a drag and drop operation of a “CustomMusic” player application window UI element 644d presented in desktop UI element 646d, dropped on attached views UI element 648d in edit window UI element 602d. In response, to detecting the drag and drop operation by one or more UI element handler components 415, communications agent 403 may interoperate with the one or more UI element handle components 415 to provide descriptor information to remote view manager component 412.

In an aspect, descriptor information may be received in response to a request from a local execution environment. FIG. 7 includes a data flow that illustrates a previous message 720 (with respect to first message 702) including a view request. Previous message 720, as shown, may be sent via network 506 by execution environment 401 of local node 504 to execution environment 401 of remote node 502 as described above. In an aspect, first message 702 may be sent in response to previous message 720.

In addition to packaging representations of data in a structure and/or format for sending a message according to a communications protocol, a content manager component 409 may operate to detect a view request received and/or otherwise identified in a message and/or data unit, of a communications protocol, received in a communication. Content manager component 409 operating in execution environment 401 of remote node 502 may receive the message, illustrated by previous message 720, in a communication with execution environment 401 of local node 504. Com-in component 411 in execution environment 401 of remote node 502 may receive the message via communication protocol component 407 and network stack 405. Previous message 720 may be delivered to execution environment 401 of remote node 502 via network 506 based on a communications address of a communicant represented by communications agent 403 in execution environment 401 of remote node 502. A communications agent may represent more than one communicant identified by different addresses.

Previous message 720 in FIG. 7 may be received in one or more packets via network 506 by network stack 405 and communications protocol component 407 in an instance of and/or analog of execution environment 401 including and/or otherwise provided by execution environment 401 of remote node 502. The data in the communication may be received by com-in component 411. Com-in component 411 may provide the data to content manager component 409. Content manager component 409 may determine one or more content types of the data. The content and/or portions of the content may be provided to one or more content type handler components 413 based on the one or more content types identified by content manager component 409. For example, FIG. 8B illustrates message portion 812b including “text/plain” MIME type identifier 814b as a content type identifier. Message portion 812b may be provided to a text/plain content handler 413. Audio data in a voice communication may be provided to an audio content handler component 413, and video data in a video communication may be provided to a video content handler component 413.

FIG. 7 includes a data flow message that illustrates a detect view request (DVR) data flow 722 that may be internal to execution environment 401 of remote node 502 and/or may include interoperation with another node via a network. With respect to FIG. 4, DRV data flow 722 may correspond to a data exchange and/or other interoperation between content handler component 409 and descriptor handler component 402 to detect and/or otherwise process the view request received in previous message 720 by execution environment 401 of remote node 504.

Com-in component 411 in execution environment 401 of remote node 502, as described above, may provide the previous message 720, received from execution environment 401 of local node 504, to content manager component 409. Content manager component 409 is operatively coupled, via com-in component 411, to communications protocol component 407 to receive data in communications with other nodes, such as execution environment 401 of local node 504. Thus, execution environment 401 of remote node 502 may receive a message via a com-in component 411 in a communication with execution environment 401 of local node 504. The message may include a view request based on view information identified by a user to communications agent 403 in execution environment 401 of local node 504.

Data received in a communication, such as in a message, may include data of various content types. In FIG. 4, communications agent 403 in execution environment 401 of remote node 502 includes one or more content handler components 413 to process data received according to its content type. Content manager component 409 may detect and/or otherwise identify a portion of the message as the view request sent from execution environment 401 of local node 504. The view request may be identified by content manager component 409 according to a schema for the message and/or a schema for the view request. For example, a portion of the message may include a MIME-type identifier that identifies the portion as a view request and/or otherwise identifies the portion for routing to descriptor handler component 402 operating in and/or otherwise on behalf of execution environment 401 of remote node 502. Alternatively or additionally, the view request may have a structure and/or content that is valid and identifiable according to a schema for defining and/or otherwise identifying valid view requests. A descriptor handler component 402, may be provided as a type of content handler component, in an aspect. Alternatively or additionally, a descriptor handler component 402 may interoperate with one or more content handler components to detect a view request in a message received by a content manager component.

As such, descriptor handler component 402 may operate along with other content handler components 413 to process data representations received in the previous message 720 from execution environment 401 of local node 504. Descriptor handler component 402 may also provide transformed data from the representations to one or more user interface element handler components 415. Descriptor handler component 402 may operate to validate and process view requests according to a schema defining valid view requests. Various portions of a message including a view request may be provided to one or more content handler components 413, including descriptor handler component 402, to interoperate with presentation controller component 417 in execution environment 401 of remote node 502 to present some or all of the received message, including the view request.

As described above, in various aspects, a view request may be detected and/or represented based on various syntaxes, grammars, vocabularies, and/or languages. For example, a view request may be identified and/or represented according to a file system search syntax, a regular expression language, a structured query language (SQL) query, a universal remote executable identifier schema, an XPATH based language, an XQuery based language, an XML based language, an HTML based language (form-based), and/or a keyword-value pair based language.

A view request and/or a view descriptor in a communication may be communicated via a network according to a first communications protocol. A communicant message may be exchanged between communicants in the communication via a second communications protocol. For example, a view request and/or a view descriptor may be sent on behalf of a first communicant by execution environment of a local node including a communications agent representing the first communicant. The view request and/or the view descriptor may be included in a communication along with a communicant message sent to the execution environment of a remote node. The communicants represented by the execution environment of the local node and the execution environment of the remote node may communicate via one or more exchanges of audio exchanged via a voice over IP (VoIP) communications protocol.

FIG. 7 further includes a data flow message that illustrates a locate message 724, that may be included in an aspect of the method illustrated in FIG. 2B, for locating one or more remote executables, presentation spaces, UI elements, and/or other view sources based on the view request. The view request may include and/or otherwise identify a matching criterion. The matching criterion may be identified by view information identified by the communicant represented by execution environment 401 of local node 504. The one or more remote executables, presentation spaces, UI elements, and/or other view sources may be located and/or otherwise identified by determining one or more view sources that match the matching criterion. The matching view source(s) may be in a data store in and/or otherwise accessible to execution environment 401 of remote node 502, such as one or more files in a file system of execution environment 401 of remote node 502. Locate message 724 may be internal to execution environment 401 of remote node 502 and/or may include a message exchanged with a remote device, such as database server and/or a network attached storage device providing storage locations for some or all of a file system of execution environment 401 of remote node 502.

FIG. 6F illustrates a window, view window UI element 602f, presenting an exemplary representation some or all data in a message, such as previous message 720, received in a communication from execution environment 401 of local node 504 by remote node 502. view window UI element 602f includes a sending communicant UI element 604f, a recipient communicant UI element 606f, and a presentation space 608f of the view window UI element 602f that includes a communicant message UI element 610f including a communication message from the communicant represented by execution environment 401 of local node 504. The various UI elements may be presented by one or more UI element handler components 415 in communications agent 403 operating in execution environment 401 of remote node 502. A reply UI element 662f and a reply all UI element 664f are illustrated as exemplary UI elements in presentation space 608f presented to allow a user of execution environment 401 of remote node 502 to respond and/or otherwise perform an operation based on the received message. FIG. 6F illustrates a view request UI interface element 666f where the view request identified in the message from execution environment 401 of local node 504 is represented to the communicant represented by the execution environment 401 of remote node 502. In an aspect, the communicant is allowed to authorize the request by providing an input corresponding to a find and reply UI element 668f. In another aspect, the communicant may be allowed to modify the view request.

Content manager component 409 may detect content type information to detect a view request in a communication. For example, the message portion illustrated in FIG. 8B may be received in previous message 720. Content manager component 409 may detect “application/view-request” MIME type identifier in content-type header 804b. The “application/view-request” MIME type identifier may be defined to identify a view request based on one or more matching criterion for identifying a requested remote executable. Content manager component 409 may identify view request portion 802b as including the view request.

In response to detecting a view request in previous message 720, content manager component 409 may provide some or all of the view request to descriptor handler component 402. For example, descriptor handler component 402 may be configured to operate according to a schema defining a format and/or a vocabulary for an XML-based language for view-request documents. Content manager component 409 may provide view-request document 806b, as a view request, to descriptor handler component 402. Descriptor handler component 402 may operate according to the view-request schema. In an aspect, descriptor handler component 402 may process more than one view request content type. Alternatively or additionally, execution environment 401 may include multiple descriptor handler components 402 to support multiple view request content types.

As described above, in an aspect, a user may be allowed to select which remote executables, presentation spaces, UI elements, and/or other view sources, are to be identified in a view descriptor. The user may select from one or more view sources located and/or otherwise identified by descriptor handler component 402 based on a matching criterion received. In another aspect, communications agent 403 in FIG. 4 may invoke descriptor handler component 402 automatically to locate one or more remote executables, presentation spaces, UI elements, and/or other view sources based on a matching criterion identified in a view request and in response to detecting a view request in a communication, such previous message 720 in FIG. 7. In another aspect, communications agent 403 may invoke descriptor handler component 402 automatically to locate one or more remote executables, presentation spaces, and/or UI elements based on a view request in a communication in response to detecting an indication to present, via a output device, some or all of a communicant message received in a message in the communication. Descriptor handler component 402 may be invoked and/or may operate based on the view request and/or matching criterion identified to locate a remote executable, a presentation space, presentation information, and/or a UI element prior to, during, and/or after other content received in the communication is processed.

FIG. 6G illustrates a results window UI element 670g includes results pane UI element 672g including representations of two remote executables located and/or otherwise identified by communications agent 403 based on the view request. A user may select one or more remote executables to identify descriptor information for constructing a view descriptor. An attach UI element 674g may be presented, as illustrated, to allow a user to instruct communications agent 403 to identify one or more selected remote executables in results pane UI element 672g in descriptor information. An attach all UI element 674g is illustrated to allow for user input instructing communication agent 403 to identify all remote executables represented in the UI element 670g in descriptor information to create one or more view descriptors. A cancel UI element 678g allows a user to end presentation of results window UI element 670g. A user may opt to identify no remote executables represented in the dialog UI element 670g and located and/or otherwise identified by navigator component 429 based on the view request.

Remote executables, presentation spaces, presentation information, UI elements, and/or other view sources located and/or otherwise identified may be identified by descriptor information to a descriptor generator component 414 in remote view manager component 412 to construct and/or otherwise create one or more view descriptors. As described above, in an aspect, a user may be allowed to select which remote executables, presentation spaces, presentation information, UI elements, and/or other view sources, if any, are to be identified in descriptor information from one or more view sources located and/or otherwise identified and/or at the direction of communications agent 403. In another aspect, communications agent 403 in FIG. 4 may automatically locate and/or otherwise initiate locating one or more view sources based on a matching criterion identified in a view request and in response to detecting a view request in a communication. In another aspect, communications agent 403 may automatically locate and/or otherwise initiate locating one or more view sources based on a view request in a communication in response to detecting an indication to present, via a output device, some or all of a communicant message received in the communication. Navigator component 429 may be invoked and/or may operate based on the view request and/or matching criterion identified to locate one or more remote view sources prior to, during, and/or after other content received in the communication is processed.

In an aspect, descriptor information may be received in response to a user input, detected by a input device of the remote execution environment. The user input may identify an output device including a presentation space as a view source for presentation data. The user input may be processed to identify the presentation space as the view source for a view descriptor. The presentation space may include a UI element presented based on presentation information sent by a component operating in the remote execution environment. In a further aspect, the user input may identify a location, in the presentation space, that corresponds to a UI element presented by a component operating in the remote execution environment. The location may be identified as a view source identified by descriptor information. That is, a UI element is represented by presentation data sent based on a view descriptor created based on the descriptor information.

A presentation space identified as a view source may be included in another presentation space. That is a portion of a presentation space is also a presentation space. A UI element and/or otherwise a representation of a UI element identified as a view source may be included in and/or otherwise presented in another UI element.

In yet another aspect, a remote execution environment may process a presentation space according to multiple modes or states. A selection mode specified where a user input that corresponds to a UI element and/or region in the presentation space is processed to identify the UI element and/or region a view source. A first user input may be detected that is defined to activate selection mode for a presentation space. A second user input detected after the execution environment has activated selection mode in response to the first input and while selection mode remains activated, may be processed to identify a region of the presentation space. Descriptor information may be generated and/or modified to identify the region as a view source. Presentation data to be sent to a local node is based on and represents the region. The selected region may include UI element presented based on the presentation information to present the UI element by a component operating in the remote execution environment. GUI subsystem 423 may include instructions to activate and deactivate a “selection mode”.

A user input for receiving descriptor information may be processed by a communications agent. For example, descriptor information may be received by a communications agent in response to a drop portion of a drag and drop operation performed in a remote execution environment The drag and drop operation may process a user selected region of a presentation space of a display device of the remote execution environment by identifying the region to the communications agent in the descriptor information.

A user input that corresponds to a specified UI input control included in a UI element in a presentation space of a remote execution environment may be defined to be processed to identify the UI element in descriptor information. The descriptor information may be provided to and/or otherwise received by a communications agent operating in the remote execution environment. Such an input control may be processed by the remote execution environment as a system control. For example, an input control may be included in frames of applications windows. Descriptor information received and/or generated in response to an input that corresponds to such an input control may be received by a communications agent operating in the execution environment. Alternatively or additionally, such an input control may be included in a menu UI element of an application window or dialog and/or in a tool bar UI element.

A user input may be predefined by a remote execution environment to identify a corresponding region of a presentation space of a display device of the remote execution environment to the remote communications agent in descriptor information.

In another aspect, descriptor information may identify a executable such as a file that includes instructions for an application. A user input may be detected that corresponds to a location in a data store of a remote execution environment. The location may include and/or otherwise identify component that may be loaded into a processor memory of the remote execution environment for executing by a processor included in the remote execution environment. The component may be identified as a view source by a view descriptor received by a communications agent in the remote execution environment, in response to detecting the user input. The location in the data store may be included in a location that represents some or all of a desktop for a user of the remote execution environment.

Receiving descriptor information may include presenting a locator user interface in response to detecting a user input. The locator user interface may be presented by and/or at the direction of a communications agent. Selection information may be received, via interaction with the user. The selection information may identify a component of the remote execution environment represented in and/or by the locator UI element. The descriptor information may be received and/or generated based on the selection information. A component identified by descriptor information as a view source may operate to present a desktop to a user of the remote execution environment.

In another aspect receiving descriptor information may include receiving, via a network, a previous message, by a remote execution environment and sent by a local communications agent. The previous message may include a view request. The previous message is addressed to a user represented by a communications agent in the remote execution environment. The descriptor information may be received in response to receiving the view request in the previous message. The descriptor information may be identified by and/or otherwise generated based on the view request.

A view request may include one or more of authentication and access control information for at least one of a node of the local execution environment, the local execution environment, a component of the local execution environment, a user of the local execution environment, and a group that includes a user of the local execution environment.

Receiving the previous message may include: detecting the view request in the previous message separate from a communicant message included in the previous message. The view request may be included in the previous message according to a schema that identifies the previous message as valid according a communications protocol in the communication.

The view request in the previous message may be sent and/or received in a communication that includes an exchange between the remote execution environment and the local execution environment of at least one of video communicant message and an audio communicant message input by and/or otherwise received via interaction with a user.

The view request in the previous message may be included in at least one of an email, an instant message, a multi-media message, a short-message service message, a data stream may be identified in the previous message based on a location of the view request in the previous message and/or based on an identifier associated with the view request. The location may be relative to a location of another identifiable portion of the previous message.

A view request may include some or all of a keyword expression, a regular expression, expression including a Boolean operator, an expression including a precedence information, and a structured query language statement.

A view request may include information for generating and/or modifying the presentation data by a remote execution environment. In an aspect a view request may include includes information for the remote execution environment to generate and/or modify a view source in the remote execution environment. Presentation data, received based on a view descriptor received in response to sending the view request, is based on data accessed from the view source. For example, a view request may include and/or otherwise identify a script or other component including an instruction that when executed by a processor in execution environment 401 of remote node 502 may create and/or modify a presentation space, change an attribute of a UI element, and/or change a configuration and/or attribute of a component that sends remote presentation information for presentation. A remote view handler component 416 may operate to identify a script or application that may be created, is being created, and/or has been created based on such a view request

In an aspect, a locator user interface may be presented based on view request. Selection information may be received from a user that identifies a component via the locator UI element. Descriptor information may be received based on the selection information. Further, view request change information may be received in response to a user input, detected via an input device. The view request may be changed based on the change information. Descriptor information may be received based on the change to the view request.

Returning to FIG. 2B, a block 214 illustrates that the method further includes locating, automatically based on the descriptor information, a view descriptor to configure a local protocol endpoint in the local execution environment, wherein the locating is initiated by the remote communications agent. Accordingly, a system for exchanging presentation data based on a communication includes means for locating, automatically based on the descriptor information, a view descriptor to configure a local protocol endpoint in the local execution environment, wherein the locating is initiated by the remote communications agent. For example, the arrangement in FIG. 3B, includes descriptor generator component 314 that is operable for locating, automatically based on the descriptor information, a view descriptor to configure a local protocol endpoint in the local execution environment, wherein the locating is initiated by the remote communications agent. FIG. 4 illustrates descriptor generator component 414 as an adaptation and/or analog of descriptor generator component 314 in FIG. 3B. One or more descriptor generator components 414 operate in an execution environment 401. The system for exchanging presentation data based on a communication includes one or more processors and logic encoded in one or more tangible media for execution by the one or more processors that when executed is operable for locating, automatically based on the descriptor information, a view descriptor to configure a local protocol endpoint in the local execution environment, wherein the locating is initiated by the remote communications agent. In FIG. 4, descriptor generator component 414 is illustrated as a component of communications agent 403.

As described above, FIG. 7 illustrates a locate view descriptor (locateVD) data flow 714. Locate view descriptor data flow 714 may result from a request from a local node, described above, and/or may result in descriptor information received in response to user input, also described above. Descriptor information received by remote view manager component 412 may be provided to and otherwise identified to a descriptor generator component 414 which may also be included in locate descriptor data flow 714. Descriptor generator component 414 operates to create and/or otherwise locate a view descriptor.

One or more view sources located and/or otherwise identified by descriptor information received by communications agent 403 may be identified to descriptor generator component 414 to construct and/or otherwise create a view descriptor identifying the view sources. Descriptor generator component 414 may include a type of content handler component that operates to process descriptor information to create a view descriptor that conforms to a schema for creating and/or otherwise constructing a valid view descriptor. The descriptor generator component 414 may construct and/or otherwise create a view descriptor based on a schema that defines and/or otherwise identifies a valid view descriptor for a particular type of communication supported by a communications agent 403. The view descriptor may be constructed and/or otherwise created, based on the descriptor information, by the descriptor generator component 414.

Descriptor generator component 414 in execution environment 401 of remote node 502 may provide the view descriptor to content manager component 409 to include and/or otherwise identify the view descriptor in a communication with execution environment 401 of local node 504, such as an email and/or instant message. Content manager component 409 may interoperate with other types of content handler components 413 to create and/or otherwise construct a message that includes the valid view descriptor.

A view descriptor may be included in a message according to a protocol schema that identifies the message as valid according to a communications protocol. In an aspect, the descriptor generator component 414 may interoperate with the content manager component 409 to create a valid view descriptor according to a specified schema for the message, so that the message is valid according to a communications protocol supported by a communications protocol component 407 that operates to send the message. As described above, the content manager component 409 may operate in execution environment 401 of remote node 502 along with a descriptor generator component 414 to transform descriptor information into a view descriptor to include along with data for other parts of a communication into one or more representations suitable for transmitting in a data unit and/or message, of a communications protocol, in a communication with another node, such as local node 504. Some or all of the representations transmitted are suitable for processing by the communications agent in execution environment 401 of local node 504. The content manager component 409 in the execution environment 401 of remote node 502 may package and/or may otherwise prepare for packaging the one or more data representations including the view descriptor into a data unit or message formatted according to the communications protocol.

A descriptor generator component 414 and/or a content manager component 409 may operate to construct a view descriptor in data unit and/or message of a communications protocol. A content type identifier may be included in a position and/or location that identifies a view descriptor in a communication. The position or location may be absolute or relative. For example, a schema for a communication may define that a view descriptor in a communication is included in the communication at the end of the communication. There may be one or more view descriptors at the end. In another aspect, a schema for a communication may specify that a portion of a communication following, for example, a communicant message portion is a view descriptor. Other view descriptors may follow. If no view descriptor is included, the view descriptor portion may be absent, include no content or may include an indicator that no view descriptor is included.

FIG. 8A includes an exemplary content portion 800a of an email message. Email message portion 800a includes a communicant message portion 802a and a view descriptor portion 804a described in more detail above. FIG. 8A illustrates an “application/view-descriptor” MIME type identifier that may be defined to identify a schema for content including one or more view descriptors. FIG. 8A illustrates a view descriptor 804a including two identifiers for accessing the “CustomMusic” player user interface. A first identifier 808a illustrates a Samba URL for accessing a “CustomMusic” VNC profile via a Samba file sharing system. The second identifier 810a illustrates an HTTP URL that may allow a receiving node to access an ICA profile via a Web server operating in and/or available to an execution environment sending the view descriptor 804a. An FTP URL 812a illustrates a file transfer protocol (FTP) that may allow a receiving node to access an RDP profile via a FTP server operating in and/or available to an execution environment sending the view descriptor 804a

The view profiles may be pre-existing in execution environment 401 of remote node. Alternatively or additionally, one or more view profiles may be created in constructing the view descriptor. A view profile and/or a view descriptor may be generated from a template including default values. For example, execution environment 401 of remote node 502 may include a script or application template stored in a file system. A view request may identify the template. A descriptor handler component 402 may operate to identify a script or application that may be created, is being created, and/or has been created based on the template. Execution environment 401 of remote node 502 may return descriptor information that identifies the results of creating and/or modifying the template, in response to receiving a view request.

View profile and/or view descriptor generating may be automatic or in some instances may require and/or otherwise allow a user to provide input for generating a view profile and/or a view descriptor.

A view descriptor may include authentication and/or access control information for at least one of a node the local execution environment, the local execution environment, a component of the local execution environment, a user of the local execution environment, and a group that includes a user of the local execution environment.

Returning to FIG. 2B, a block 216 illustrates that the method yet further includes sending, via a communications protocol based on a local communications address identifying a local user represented by a local communications agent in a local execution environment, the view descriptor to the local communications agent by the remote communications agent. Accordingly, a system for exchanging presentation data based on a communication includes means for sending, via a communications protocol based on a local communications address identifying a local user represented by a local communications agent in a local execution environment, the view descriptor to the local communications agent by the remote communications agent. For example, the arrangement in FIG. 3B, includes remote view content handler component 316 that is operable for sending, via a communications protocol based on a local communications address identifying a local user represented by a local communications agent in a local execution environment, the view descriptor to the local communications agent by the remote communications agent. FIG. 4 illustrates remote view content handler component 416 as an adaptation and/or analog of remote view content handler component 302 in FIG. 3B. One or more remote view content handler components 416 operate in an execution environment 401. The system for remote view content handler includes one or more processors and logic encoded in one or more tangible media for execution bye the one or more processors that when executed is operable for sending, via a communications protocol based on a local communications address identifying a local user represented by a local communications agent in a local execution environment, the view descriptor to the local communications agent by the remote communications agent. In FIG. 4, a remote view content handler component 416 is illustrated as a component of application 403.

As described above, FIG. 7 illustrates first message 702, including a view descriptor, sent via network 506 by execution environment 401 of remote node 502 to execution environment 401 of local node 504. In an aspect described below, first message 702 may be sent in response to previous message 720.

A view descriptor generated by a descriptor generator component 414, along with a communicant message and any other data to include in a communication, may be provided and/or otherwise identified to content manager component 409 for sending in the communication. A remote view content handler component 416 may interoperate with content manager component 409 in execution environment 401 of remote node 502 to package data from descriptor generator component 414 including into a representation suitable for including the view descriptor in a data unit and/or message formatted according to the communications protocol.

Remote view content handler component 416 may, via content manager component 409, invoke com-out component 419. Com-out component 419 may provide the view descriptor, the communicant message, and any other data to send in the communication in representations suitable for sending by communications protocol component 407 to the communications agent in execution environment 401 of local node 504. Communications protocol component 407 operating in execution environment 401 of remote node 502 may send the data as and/or in a communication, such as an email message, according to the specification(s) of the communications protocol. Communications protocol component 407 may further package and/or otherwise transform the data to send via network stack 405 for delivery via network 506 to execution environment 401 of local node 504.

Content manager component 409 may alternatively or additionally encode and/or otherwise transform one or more of the data representations for sending in a data stream such as voice stream and/or a video stream for communicating in a communication with the communications agent in execution environment 401 of local node 504.

A view descriptor may be exchanged in a communication that includes an exchange, via the network via a first communications protocol for exchanging the view descriptor and/or via a second communication protocol, between a remote execution environment and a local execution environment of a video communicant message, an audio communicant message data, and/or text communication message input by and/or otherwise received via interaction with a communicant. The video communicant message, the audio communicant message data, and/or the text communication message may be provided by and/or otherwise received in response to interaction between a user and the remote communications agent and/or a user and the local communications agent.

A view descriptor may be included in a data unit and/or message of a communications protocol separate from a communicant message from the remote user that is also included. This is illustrated and described above with respect to FIG. 8B.

A view descriptor may be sent in a data unit and/or message of a communication protocol to a user of a local communications agent by including a communications address that identifies the local user. The address is from an address space of the communications protocol. The data unit and/or message may be from a user represented by a remote communications agent. The remote user may be identified in the data unit and/or message by communications address in the address space of the communications protocol.

Returning to FIG. 2B, a block 218 illustrates that the method yet further includes sending, based on the local protocol endpoint to the local execution environment, the presentation data. Accordingly, a system for exchanging presentation data based on a communication includes means for sending, based on the local protocol endpoint to the local execution environment, the presentation data. For example, the arrangement in FIG. 3B, includes access server component 318 that is operable for sending, based on the local protocol endpoint to the local execution environment, the presentation data. FIG. 4 illustrates access server component 418 as an adaptation and/or analog of access server component 318 in FIG. 3B. One or more access server components 418 operate in an execution environment 401. The system for exchanging presentation data based on a communication includes one or more processors and logic encoded in one or more tangible media for execution by the one or more processors that when executed is operable for sending, based on the local protocol endpoint to the local execution environment, the presentation data. In FIG. 4, a access server component 418 is illustrated as a component of application 403.

As described above, FIG. 7 includes a dataflow that illustrates a third message 710 transmitted via network 506 by execution environment 401 of remote node 502 to execution environment 401 of local node 504. The presentation data may be sent in response to receiving the presentation request in second message 708. In another aspect, presentation data may be sent asynchronously to execution environment 401 of the local node 504 without receiving a request.

In FIG. 4, presentation data may be sent by an access server component 418 in execution environment 401 of remote node 502. Thus, the dataflow illustrated by third message 718 may be a message sent via a VNC server, an ICA server, an RDP server, and/or other remote view server operating in execution environment 401 of remote node 502. Such servers are illustrated in FIG. 4 by access server component 418. An access server sending presentation data may interoperate via network 506 with an access agent component operating in execution environment 401 of local node 504. Examples of an access agent component include a VNC client, an ICA client, an RDP client, and/or other access agent types operating in execution environment 401 of local node 504.

As described, a presentation request may be received by a remote execution environment from a local execution environment in response to sending a view descriptor to the local execution environment. Presentation data accessible via the view descriptor may be sent to the local execution environment, in response to receiving the presentation request.

A presentation request may include authentication and/or access control information for a node of the local execution environment, the local execution environment, a component of the local execution environment, a user of the local execution environment, and/or a group that includes a user of the local execution environment.

The methods illustrated in FIG. 2A-B may yet further include additional aspects supported by various adaptations and/or analogs of the arrangement of components in FIG. 3A-B. Performing the method illustrated in FIG. 2A and/or the method illustrated in FIG. 2B and/or any of its extension and/or in any of its aspects may include one or more of calling a function or method of an object, sending a message via a network; sending a message via an inter-process communication mechanism such as a pipe, a semaphore, a shared data area, and/or a queue; and/or receiving a request such as poll and responding to invoke, and sending an asynchronous message.

Output devices suitable for presenting a representation presentation data include a visual output device, an audio output device, and a tactile output device. One output device may present a view source and another output device may present a tag with which the view source is tagged.

Any action included in performing the method illustrated in FIG. 2A as well as any action included in performing the method illustrated in FIG. 2B may include sending and/or receiving a message via a network. Further, a message, included in performing any of the subject matter described herein and/or any of its extensions in any of its aspects, may an asynchronous message without a corresponding request.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein may be embodied in executable instructions stored in a tangible computer readable storage medium for use by or in connection with an instruction execution machine, system, apparatus, or device, such as a computer-based or processor-containing machine, system, apparatus, or device. As used here, a “tangible computer readable storage medium” may include one or more of any suitable media for storing the executable instructions of a computer program in one or more forms including an electronic, magnetic, optical, and electromagnetic form, such that the instruction execution machine, system, apparatus, or device may read (or fetch) the instructions from the tangible computer readable storage medium and execute the instructions for carrying out the described methods. A non-transitory computer readable storage medium is tangible. A non-exhaustive list of conventional exemplary tangible computer readable storage media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), and a Blu-ray™ disc; and the like

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method for exchanging presentation data based on a communication, the method comprising:
receiving, by a remote communications agent in a remote execution environment, descriptor information for identifying presentation data representing remote presentation information, sent by a remote component operating in the remote execution environment, to be represented in a first presentation space in the remote execution environment;
locating, automatically based on the descriptor information, a view descriptor to configure a local protocol endpoint in the local execution environment, wherein the locating is initiated by the remote communications agent;
sending, via a communications protocol based on a local communications address identifying a local user represented by a local communications agent in a local execution environment, the view descriptor to the local communications agent by the remote communications agent; and
sending, based on the local protocol endpoint to the local execution environment, the presentation data,
wherein performing at least one of the preceding actions comprising the method includes execution of an instruction by a processor.

2. The method of claim 1 wherein receiving the descriptor information includes identifying a view source in response to a drop portion of a drag and drop operation performed in the remote execution environment, wherein the drag and drop operation operates on a user selected region of a presentation space of a display device of the remote execution environment.

3. The method of claim 1 wherein the descriptor information is received in response to a user input, detected by a input device of the remote execution environment, corresponding to a descriptor UI element in a user interface of the remote component, wherein the user input, based on corresponding to the descriptor UI element, is defined to instruct a process in which the remote component is operating to identify the descriptor information to the remote communications agent.

4. The method of claim 1 receiving the descriptor information further includes:
presenting a locator user interface response to a user input, detected by a input device of the remote execution environment;
receiving selection information identifying the remote component via the locator UI element; and
receiving the descriptor information based on the selection information.

5. The method of claim 1 wherein receiving the descriptor information includes:
receiving, via the network, a previous message, by the local communications agent, including a view request, wherein the previous message is addressed to the local user; and
receiving the descriptor information, in response to receiving the view request in the previous message.

6. The method of claim 5 wherein the view request identifies a scope specifying at least a portion of the remote execution environment for locating a view source.

7. The method of claim 5 wherein the view request includes information for the local execution environment for at least one of generating and modifying a view source.

8. The method of claim 5 further includes:
receiving view request change information in response to a user input, detected via an input device;
changing the view request based on the change information; and
receiving the descriptor information based on the changing.

9. The method of claim 1 wherein the view descriptor is created according to schema, identified based on the first communications protocol, that identifies at least one of a rule and a vocabulary for at least one of determining that the view descriptor is valid and for determining an identifier of the view descriptor

10. The method of claim 1 wherein the first communications protocol includes a protocol specified for exchanging at least one of an email, an instant message, a short messaging service message (SMS), a multi-media message (MMS), an audio message, a video message, and an attachment.

11. The method of claim 1 further includes:
receiving, in response to sending the view descriptor, a presentation request from the local execution environment to access the presentation data; and
sending the presentation data to the local execution environment.

12. A method for exchanging presentation data based on a communication, the method comprising:
identifying, by a local communications agent in a local execution environment, data as a view descriptor, wherein the data is received by the local communications agent in a communication, via a network, with an other communications agent in an other execution environment, wherein the view descriptor is identified for accessing presentation data representing remote presentation information sent by a remote component operating in a remote execution environment for representing in a first presentation space in the remote execution environment;
configuring, based on the view descriptor, a local protocol endpoint in the local execution environment;
receiving, by the local execution environment and based on the local protocol endpoint, the presentation data; and
sending local presentation information, based on the presentation data, to present a representation of the remote presentation information via an output device of the local execution environment,
wherein performing at least one of the preceding actions comprising the method includes execution of an instruction by a processor.

13. The method of claim 12 wherein receiving the view descriptor includes:
receiving, by the local execution environment, view information, identifying an matching criterion, from the local user;
sending a view request, based on the matching criterion, to the other communications agent, wherein the view request is sent via a communication protocol based on a communications address that identifies an other user represented by the other communications agent; and
receiving the view descriptor in response to sending the previous message.

14. The method of claim 13 wherein sending the view request includes including the view request in a previous message by the local communications agent along with a separate communication message from the local user, wherein the view request is created according to a schema that identifies at least one of a rule and a vocabulary for at least one of including the view request in the previous message and identifying that the view request in the previous message.

15. The method of claim 12 wherein the configuring includes determining, by the local communications agent, a second location in a local data store of the local execution environment for at least one of representing and storing a view profile based on the received view descriptor, in response to detecting a user input included in performing a drag and drop operation on a representation of the view descriptor presented by the local communications agent via an output device.

16. The method of claim 12 wherein said configuring includes: identifying an access agent component based on a presentation protocol identified based on the view descriptor; determining that the access agent component is not present in the local execution environment; retrieving via the network the access agent component based on the view descriptor; and configuring the local protocol endpoint based on the access agent.

17. A system for exchanging presentation data based on a communication, the system comprising:
a descriptor handler component or identifying, by a local communications agent in a local execution environment, data as a view descriptor, wherein the data is received by the local communications agent in a communication, via a network, with an other communications agent in an other execution environment, wherein the view descriptor is identified for accessing presentation data representing remote presentation information sent by a remote component operating in a remote execution environment for representing in a first presentation space in the remote execution environment;
an access director component for configuring, based on the view descriptor, a local protocol endpoint in the local execution environment;
an access agent component for receiving, by the local execution environment and based on the local protocol endpoint, the presentation data;
a local view manager component for sending local presentation information, based on the presentation data, to present a representation of the remote presentation information via an output device of the local execution environment; and
a processor, wherein at least one of the descriptor handler component, the access director component, the access agent component, and the local view manager component includes an instruction that is executed by the processor during operation of the system.

18. A tangible computer readable storage medium embodying a computer program, executable by a machine, for exchanging presentation data based on a communication, the computer program comprising executable instructions for:
identifying, by a local communications agent in a local execution environment, data as a view descriptor, wherein the data is received by the local communications agent in a communication, via a network, with an other communications agent in an other execution environment, wherein the view descriptor is identified for accessing presentation data representing remote presentation information sent by a remote component operating in a remote execution environment for representing in a first presentation space in the remote execution environment;
configuring, based on the view descriptor, a local protocol endpoint in the local execution environment;
receiving, by the local execution environment and based on the local protocol endpoint, the presentation data; and
sending local presentation information, based on the presentation data, to present a representation of the remote presentation information via an output device of the local execution environment.
